(19) United States
(12) Patent Application Publication
(10) Pub. No.: US 2008/0040364 A1
(43) Pub. Date: Feb. 14, 2008

(54) Extensible multi-dimensional framework

(76) Inventor: Di Li, Vancouver (CA)

Correspondence Address: DI LI, 3563 Renfrew Street, Vancouver, BC, V5M 3L5, US

(21) Appl. No.: 11/807,452

(22) Filed: May 29, 2007

(51) Int. Cl. G06F 17/30

(52) U.S. Cl. 707/100

(57) ABSTRACT

Extensible Multi-Dimensional Framework (EMDF) is a system engineering framework for designing, developing and managing enterprise information technology systems. It includes two parts: multi-dimensional architecture framework (MDAF) and three-dimensional unified process (3DUP). MDAF includes comprehensive concepts for modeling an enterprise information technology system. 3DUP provides an iterative system development process. EMDF addresses an enterprise information technology system as a single entity. By projecting this entity on intertwined MDAF dimensions through the 3DUP lifecycle, all logical or physical elements encompassed in the entity will be exposed and captured in well-organized artifacts defined in MDAF. These elements are then prioritized and scheduled in a set of agile iterations. The iterations will be planned in parallel projects implemented by multiple development teams. During a long-term system development lifecycle, some elements may change. The dimensions included in MDAF provide a flexible framework to adjust system architectures, iterations and projects in order to adapt to such changes. The key deliverables of EMDF include an adaptive-to-change quality-focused architecture, optimistic agile iterations, and a market-centric business-driven risk-mitigating process.

### REFERENCES CITED [REFERENCED BY]

“SunTone Architecture Methodology, 3-Dimenstional Approach to Architectural Design, White Page”, by Sun Microsystems, 2001
“Business Modeling with UML, Business Patterns at Work”, by Hans-Erik Eriksson and Magnus Penker, Wiley Computer Pulishing, 2000
“Requirements Analysis, From Business View to Architecture”, by David C. Hay, Pearson Education Inc., 2003
“Software Systems Architecture: working with stackholders using viewpoints and perspectives”, by Nick Rozanski and Eoin Woods, Pearson Education Inc., 2005
“Agile Software Development: Principles, Patterns and Practices”, by Robert Cecil Martin, Pearson Education Inc., 2005
“Agile estimating and planning”, by Mike Cohn, Pearson Education Inc., 2006
“UML2 and the unified process: practical object-oriented analysis and design, second edition”, by Jim Arlow and Ila Neustadt, Pearson Education Inc., 2005
“The Enterprise Unified Process: extending the rational unified process”, by Scott W. Ambler, John Nalbone and Micheal J. Vizdos, Pearson Education Inc., 2005
“The Rational Unified Process: an introduction, third edition”, by Philippe Kruchten, Pearson Education Inc., 2004
“Introduction to algorithms”, by Thomas H. Cormen, Charles E. Leiserson and Ronald L. Rivest, The Massachusetts Institute of Technology, 1990

### 1. BACKGROUND OF THE INVENTION

1.1 Field of the Invention

The present invention relates to system engineering, more particularly to a system architecture framework and a system lifecycle model to develop and manage enterprise information technology systems.

1.2 Description of the Related Art

The explosion of new generation e-business has fundamentally changed the mission and success factors IT organizations are facing. The new-generation e-business provides integrated business services, offers end-to-end automated business processes, and supports a highly dynamic market. It requires new generation enterprise information technology systems that support dynamic, real-time, automated and integrated business environments. IT organizations are currently facing challenges in developing such systems due to the lack of appropriate enterprise-wide system engineering frameworks.

The silo-based implementation in current enterprise information technology systems causes the fracture of functions, technologies and system quality. It increases the complexity and difficulty when creating new value-added services by combing the functionalities of various existing systems. The silo problem is mainly introduced by the history of legacy system evolution, decentralized development, and the lack of platform standard. However until very recently, the vast majority of IT organizations have still been developing many silo systems.

The complex nature of business demands the specialization of computer systems due to the lack of effective enterprise-wide frameworks, which can be used to guide the development of an enterprise information technology system. The specialization produces silos. Each application is charted and funded by a single line of business. Each application has a focused goal, and uses different technologies and platforms. Silos result in inefficient and fragile systems.

Corporate IT organizations have and continue to suffer failure, delay and out-of-budget in project development. The traditional unified process is not effective to solve these problems when developing large-scale, cross-business enterprise information technology system in a parallel development environment in which multiple teams develop different projects at the same time. The following issues illustrate some drawbacks for using traditional iterative development approaches in developing an enterprise information technology system.
The conflict between long-term lifecycle of an enterprise information technology system and short-term period of an iteration. The development lifecycle of an enterprise information technology system usually spans several years. In contrast, an iteration lifecycle is usually planned by weeks. “Missing Target” problem may occur under this situation. The “Missing Target” problem represents the case in which an iteration has been successfully released, however, its implementation does not mach the final target of an enterprise information technology system.
The conflict between the parallel development process of an enterprise information technology system and the iteration dependency. Developing an enterprise information technology system is a complex process. It involves decomposing the development lifecycle of an enterprise information technology system into many iterations, which will be implemented by multiple development teams. Some iterations can be implemented in parallel, but others must be implemented in sequence. Avoiding conflicts among the iterations and planning an optimistic roadmap to implement the iterations will dramatically affect the speed and budget of developing the enterprise information technology system.

Market opportunities, external competition and customer needs force an organization to provide one-stop service to their customers. The integrated nature of one-stop service leads to a tight coupling of different business divisions. To support such business scenarios, the enterprise information technology system is required to provide any-to-any real-time interconnection among different applications. Moreover, it is also required to implement end-to-end automated business processes. The cross-business processes also increase the degree of coupling among applications. In contrast, “Loose coupling” is a golden rule for developing a computer system. The coupling determines the degree at which classes within the systems are dependent on each other. Tight coupling causes rigid systems in which a single change causes a cascade of subsequent changes in dependent modules. It also produces a fragile system in which the result of fixing an existing problem leads to more new problems. The need arises for new methods, which are not included in the traditional object-oriented analysis and design (OOAD) approaches, to bridge the gap between business and computer systems. These methods must provide an effective way to develop loosely coupled application systems that support the tightly correlated businesses.

The application systems included in an enterprise information technology system may run on a highly shared and interconnected infrastructure to decrease the total cost of ownership and simplify the implementation of any-to-any real-time interoperations among application systems. As a result, its infrastructure is working with a wider array of dependencies. This creates a logistical problem: while the applications become more modular and the infrastructure is more shared, the enterprise information technology system exposes a large number of failure points. IT organizations require tools not included in traditional system architecture frameworks to minimize inter-application dependencies and trace ongoing changes in dependencies.

Risk control is a critical issue in system development. However, traditional Object-Oriented System Development (OOSD) methodology does not provide a systematic risk management solution. The risks that arise in the system development lifecycle are major factor causing project failure. A successful project identifies risk early and creates a solution strategy early. It is especially important for developing a large-scale complex enterprise information technology system. For this reason, IT organizations require a new system-engineering framework that predicts and manages risk.

To execute end-to-end automated business processes, the enterprise information technology system is required to be more flexible, scalable, reliable, and secure than ever before, quicker than ever before, and greater system quality than ever before. Traditional system architecture framework cannot effectively meet the requirement of being adaptive-to-change high-performance and zero-down-time in one system architecture. There is thus a strong need for a new system-engineering framework to guide the design, implementation, and management of the systems that meet such requirements in the same architecture.

### 2. SUMMARY OF THE INVENTION

The present invention provides a system-engineering framework for designing, developing and managing enterprise information technology systems. It includes a system architecture framework, a system lifecycle model, and methods to inject a system architecture framework into a system lifecycle model. The important features of the present invention which make it different from other methodologies are:
an innovative architecture framework (multi-dimensional architecture framework)
an innovative iterative development process (three-dimension unified process)
an innovative set of activities for using the architecture framework in each workflow of the development process.

The present invention seeks to provide theories, models, architectures, frameworks, processes, workflows, strategies, algorithms and formulas to solve the problems and meet the requirements identified in section 1.2.

An architecture framework is provided to create an adaptive-to-change quality-focused system architecture. All application systems of an enterprise information technology system can be vertically partitioned into Application Layer, Interface Layer and Infrastructure Layer, and horizontally divided into Internet Domain, Intranet Domain, Extranet Domain and Management Domain. From vertical perspective, all application components are modeled as a series of services. A service is a software implementation of specific business logic. The interface supports the interoperations among these services via unified-formatted service contracts. The infrastructure provides any-to-any real-time interconnection among these services through a unified infrastructure framework. The generated system architecture makes each service easy to implement and modify. Moreover, it also makes the whole enterprise information technology system adaptive to change for quickly responding to any market opportunity and customer demands.

A view framework is defined as a market-centric business-driven framework to model, analyze and design the solution to implement functional requirements for application systems of an enterprise information technology system via a number of conceptual views. The static structure and the dynamic collaboration aspects nested in the views create an automatic process for achieving cross-view consistency between neighboring views. This framework provides an enterprise-wide unified approach required for combining the knowledge of both business groups and IT groups to create an adaptive-to-change enterprise information technology system.

A set of dependency viewpoints, formulas and analysis processes are defined in the present invention to capture dependencies among the elements consisting of an enterprise information technology system or an application system, and visualize, optimize and manage these dependencies.

A consistent framework is supported by the present invention to identify system quality requirements, to be easily used as enterprise-wide framework or project-wide framework for managing and implementing these requirements. As all project-level frameworks will follow the standards of an enterprise-level framework, it enables development teams to create predictive cross-systems qualities, and implement them in a set of agile iterations. As a result, the whole enterprise information technology system will be constructed with predefined system qualities.

A systematic approach for risk control is included in this invention to capture and manage risks in developing an enterprise information technology system. It includes a perspective framework to identify the various risks, an aspect framework to reuse the risk mitigation strategies, and a risk mitigating process to analyze, prevent and eliminate identified risks.

The present invention also provides an adaptive-to-change framework to create optimistic agile iterations, promote the parallel development strategy, and create predictable system-level or project-level plans to gain an optimistic roadmap for developing enterprise information technology systems.

An iterative, incremental and predictable development process is specified in this invention. It covers the whole system lifecycle, not just development lifecycle. An architecture framework is injected into this process to guide activities and artifacts in each workflow of the process through predefined strategies included in the architecture framework.

These and other objectives, features; and advantages of the present invention will become apparent after reading the following detailed description in section 4.

### 3. BRIEF DESCRIPTION OF THE DRAWINGS

For a more complete understanding of the present invention and advantages thereof, reference is now made to the following description, which is to be taken in conjunction with the accompanying drawings wherein:

FIG. 1 is an illustration of the organization and usage of Extensible Multi-Dimensional Framework;

FIG. 2 is an illustration of the structure of Layer Dimension;

FIG. 3 is an illustration of the structure of Application Layer;

FIG. 4 is an illustration of the structure of Interface Layer;

FIG. 5 is an illustration of the structure of Infrastructure Layer;

FIG. 6 is an illustration of the organization of Domain dimension;

FIG. 7 is an illustration of an architectural model for an enterprise information technology system;

FIG. 8 is an illustration of the organization of View Dimension;

FIG. 9 is an illustration of a sample Use Case Form;

FIG. 10 is an illustration of the organization of Dependency Viewpoint;

FIG. 11 is an illustration of a sample Directive Dependency;

FIG. 12 is an illustration of a sample Transitive Dependency;

FIG. 13 is an illustration of a sample Dependency Map;

FIG. 14 is an illustration of a sample Dependency Matrix;

FIG. 15 is an illustration of the organization of the perspective framework of Risk Control Dimension;

FIG. 16 is an illustration of the structure of Risk Mitigation Form

FIG. 17 is an illustration of the workflows included in the Risk Mitigation Process;

FIG. 18 is an illustration of the process to create the optimistic iteration duration;

FIG. 19 is an illustration of the disciplines to plan business cases in parallel project development;

FIG. 20 is an illustration of a sample Iteration Form;

FIG. 21 is an illustration of a sample Iteration Graph;

FIG. 22 is an illustration of a sample Iteration Graph with a cycle association;

FIG. 23 is an illustration of a sample of removing a cycle association via aggregation approach;

FIG. 24 is an illustration of a sample of removing a cycle association via decomposition approach;

FIG. 25 is an illustration of a sample of removing a cycle association via interfacing approach;

FIG. 26 is an illustration of the workflow to arrange iterations into parallel projects;

FIG. 27 is an illustration of the structure of three-dimension unified process; and

FIG. 28 is an illustration of the iterative structure of Activity Dimension/

### 4. DETAILED DESCRIPTION OF THE INVENTION

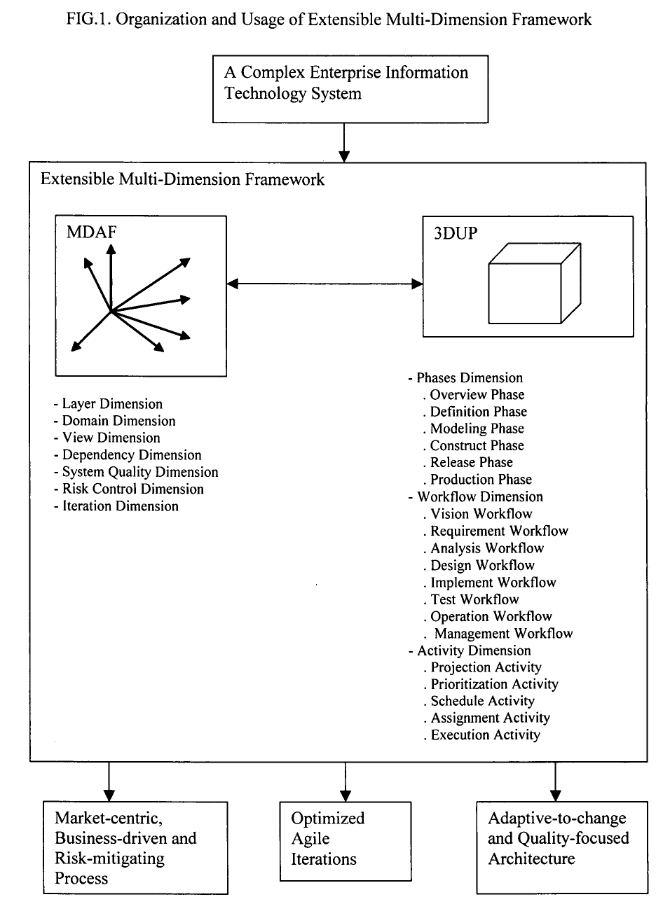

The extensible multi-dimensional framework (EMDF) is a system engineering framework to design, develop and manage current and new generation enterprise information technology systems that support dynamic, real-time, automated and integrated business environments. As shown in FIG. 1, EMDF consists of a multi-dimensional architecture framework (MDAF) and a three-dimensional unified process (3DUP). The MDAF defines the comprehensive concepts for modeling a complex enterprise information technology system. The 3DUP is an iterative system development process used to manage the development lifecycle of an enterprise information technology system.

An enterprise information technology system includes hardware components and software components. It can be used to support a specific business or all businesses of an organization. EMDF handles the enterprise information technology system as one entity. It organizes the activities of business modeling, analysis, design, implementation and management along multiple dimensions. These dimensions provide a consistent framework to address cross-business and cross-system aspects of an enterprise information technology system

When using EMDF to develop an enterprise information system, the main deliverables include a market-centric business-driven risk-mitigating process, an adaptive-to-change quality-focused architecture and a set of optimized agile iterations.

### 4.1 Multi-Dimensional Archtecture Framework

The multi-dimensional architecture framework (MDAF) consists of seven intertwined architectural dimensions: Layer Dimension, Domain Dimension, View Dimension, Dependency Dimension, System Quality Dimension, Risk Control Dimension and Iteration Dimension.

### 4.1.1 Layer Dimension

Running a business today is more competitive than ever before. To remain competitive, organizations have to quickly capture market opportunities and customers' needs, and quickly provide right solutions. The enterprise information technology system has become a critical factor that determines business success. An enterprise information technology system consists of many application systems. Each application system supports a specific business. The enterprise information technology system may include all application systems of an organization, or may represent a group of application systems that support a specific business domain. For example, the enterprise information technology system of a bank can include all application systems of the bank. It can also represent a group of application systems for supporting Bond Trading, such as pricing system, risk analysis system, transaction management system and trade entry system etc.

Developing a robust application system is a cumbersome process, which involves developers, hardware, software, design activities and documentation etc. By dividing all application system in an enterprise information technology system into an application layer, an interface layer, and an infrastructure layer, an organization can keep dynamic elements within the application layer, and reuse stable services provided by other layers. This approach enables the application systems to be flexible enough to adapt to rapidly changing requirements while making infrastructure stable enough to guarantee system quality.

Dividing an application system into the application layer, the interface layer, and the infrastructure layer also simplifies programming and enables quick software development. The application layer components focus on the implementation of business logic, the infrastructure layer components ensure real-time interconnectivity and the interface layer components address the any-to-any interoperability, which enables an application component to interoperate with other components without needing to know their location. So an application component can reuse the functionalities provided by another application component through standard interfaces. The prior component is called service consumer, and the latter one is called service provider.

An organization usually provides multiple business services. For instance, a commercial bank usually provides personal banking service, loan service and investment service etc. The organization can create a new integrated business service by combing exiting services in an end-to-end automated business process. Supporting a unified system quality across multiple services is critical to the integrated business service. However, building and maintaining zero-downtime infrastructures that support cross-business system quality is a time-consuming and cost-heavy exercise. By decomposing related application systems into the application layer, the interface layer and the infrastructure layer, an organization can take advantage of aggregating and consolidating multiple applications on a shared robust infrastructure.

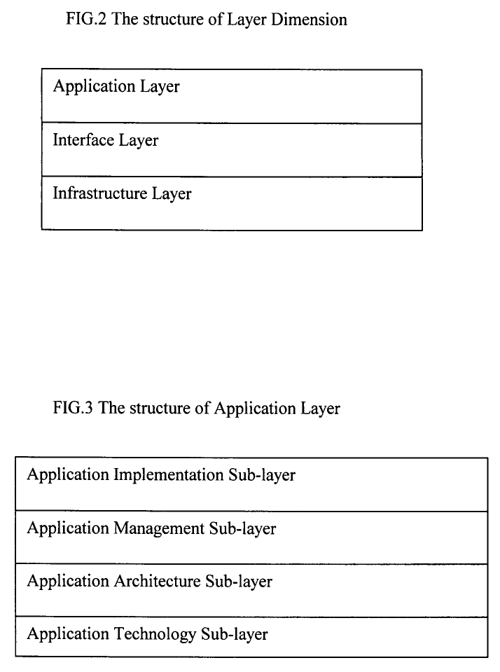

For these reasons, MDAF includes a Layer Dimension as shown in FIG. 2. This dimension defines the vertical conceptual model of an application system. An application system is divided into multiple layers based on different responsibility. The layer structure represents an ordered chain of service providers and consumers. Components on a layer typically consume services provided by those on an adjacent lower layer, and provide services to those on an adjacent upper layer.

### 4.1.1.1 Application Layer:

The application layer is the top-most layer in the Layer Dimension. It provides the implementation of business logic, and performs services for specific business tasks. Users interface directly with this layer. It consists of four sub-layers as shown in FIG. 3.
Application Implementation Sub-layer: Application software components in this sub-layer implement business logic, manage transactions, store data, and interact with users.
Application Management Sub-layer: Application software components in this sub-layer provide tools to configure applications, to monitor application performance, to trace application activities, and to report application usage statistics.
Application Architecture Sub-layer: This sub-layer includes a set of documents that specify the concrete software architecture of an application system. This concrete architecture follows an architectural template defined in the Application Technology Sub-layer, and meets all functional and non-functional requirements related to application components.
Application Technology Sub-layer: This sub-layer defines a software stack that may be used in all application systems of an enterprise information technology system. It also includes a software architectural template and best practices of using the software included in the software stack.

### 4.1.1.2 Interface Layer:

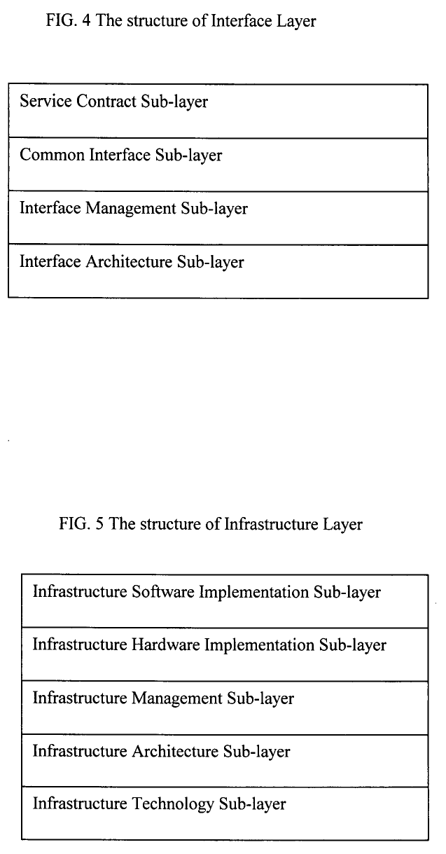

The Interface layer is the middle layer in the Layer Dimension. It provides a unified integration mechanism, which enables real-time interoperations among components running in different application systems. It consists of four sub-layers as shown in FIG. 4.
Service Contract Sub-layer: Interface software components in the Service Contract Sub-layer offer a loosely-coupled mechanism to expose the functionalities provided by different application components, and to enable collaborations among these application components.
Common Interface Sub-layer: Interface software components in the Common Interface Sub-layer provide a set of software libraries, which perform common communication services for application processes. These components standardize the mechanism by which application processes make use of the underlying infrastructure.
Interface Management Sub-layer: Interface software components in the Interface Management Sub-layer provide tools to configure service contracts, to monitor interoperation performance among application components, to trace interoperation activities among application components, and to report interoperation status statistics.
Interface Architecture Sub-layer: This sub-layer includes documents that specify the concrete architecture for developing interface components.

### 4.1.1.3 Infrastructure Layer:

The infrastructure layer is the bottom-most layer in the Layer Dimension. Hardware components and related software components in this layer provide runtime physical platform for application processes. This layer consists of five sub-layers shown in FIG. 5.
Infrastructure Software Implementation Sub-layer: Infrastructure software components in this layer include vendor-specific software products, such as operating systems, RDBMS, middleware systems and web servers etc. The documents created for this layer specify how these software components are installed, configured and interoperated.
Infrastructure Hardware Implementation Sub-layer: Hardware components in this layer include vendor-specific hardware products, such as PCs, servers, and network routers etc. The documents created for this layer specify how these hardware components are installed, configured, and connected.
Infrastructure Management Sub-layer: Infrastructure software components in this sub-layer provide tools to configure infrastructure, to monitor infrastructure performance, to trace infrastructure activities, and to report infrastructure status statistics.
Infrastructure Architecture Sub-layer: The documents created for this sub-layer specify system deployment architecture and network topology. The architecture and topology optimize the infrastructure organization and structure of an enterprise information technology system, and conform to the functional and non-functional requirements related to infrastructure components.
Infrastructure Technology Sub-layer: This sub-layer includes the hardware and software stack that may be used in the infrastructure of an enterprise information technology system. It also includes an infrastructure architectural template, a network topology template and best practices of using select hardware and software.

### 4.1.2 Domain Dimension

The end-to-end business process automation provided by new generation e-business enables organizations to expand into new markets, increase revenues, reduce their operating cost, improve customer loyalty, and outclass their competitive capacity in today's business environment. From the market's perspective, the integrated services executed in end-to-end automated business processes allow organizations to create new value-adding products with less investment and low risk by reusing existing products, business knowledge, experienced employees and application systems. From the customer's perspective, the one-stop service implemented in end-to-end automated business processes not only provides a convenience but also saves them time and money.

An end-to-end automated business process normally crosses multiple application systems of an enterprise information technology system. These application systems are usually built on the combination of Internet Technology, Intranet Technology and Extranet Technology. The problem, in many cases, is the lack of an effective architectural framework to manage the solutions that support real-time automated interoperation among disparate application systems. More importantly, a consistent architectural framework is required to control the technologies used in all application systems of an enterprise information system. Any gap among the technologies used in different application systems may result in failure in executing end-to-end automated business processes.

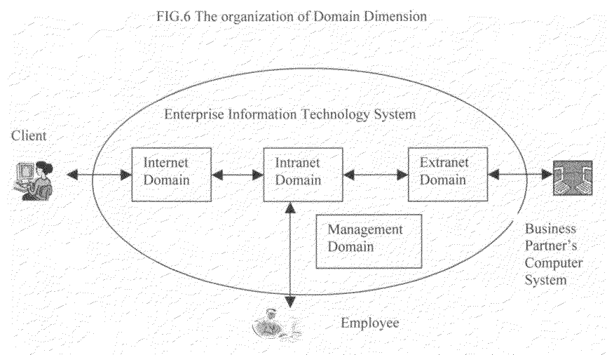

The Layer Dimension described in section 4.1.1 provides an adaptive-to-change framework for architecting an application system. However, to develop an enterprise information technology system that supports end-to-end automated business processes, a comprehensive framework is required to address the cross-cutting architectural concerns of all application systems in the enterprise information technology system, to categorize and group all architectural components, and to provide a consolidated platform for managing all hardware components and software components within the enterprise information technology system. For these reasons, MDAF includes a Domain Dimension, as shown in FIG. 6, which defines the horizontal conceptual model of an enterprise information technology system. The system is divided into four domains: an Internet Domain, an Intranet Domain, an Extranet Domain and Management Domain.
Internet Domain: The hardware and software components of application systems in this domain provide portals for clients to access the application systems, start business processes, interact with the processes, and view processes status via public networking, such as Internet or wireless network,
Intranet Domain: The components of application systems in this domain enable employees to access the application systems, start business processes, control processes execution, and manage processes status via Intranet. They support real-time automated integration among all internal application systems of an organization. The application software components in this domain provide core business services to the application software components in other domains.
Extranet Domain: The components of application systems in this domain support the business processes that cross an organization and its business partners via Extranet. They provide interconnections, and real-time interoperations among the internal application systems of an organization and the external application systems of its business partners.
Management Domain: The management domain includes all software components in the Management Sub-Layer of Application Layer, Interface Layer and Infrastructure Layer. It provides a consolidated platform to configure, monitor and manage all application systems of an enterprise information technology system. The Management Domain consists of Application Layer Management, Interface Layer Management and Infrastructure Layer Management. Each layer management provides an aggregated view to design and manage the software components in the related Management Sub-Layer across Internet Domain, Intranet Domain and Extranet Domain, respectively.

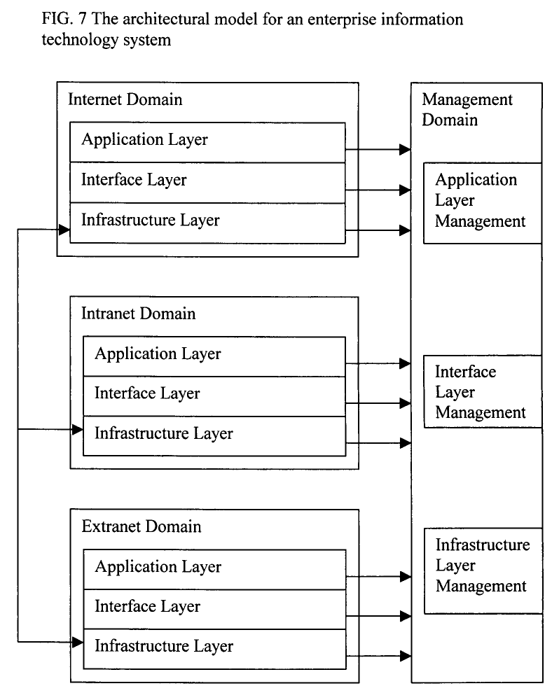

Intertwining the Domain Dimension and the Layer Dimension can create an architectural model for an enterprise information technology system, as shown in FIG. 7. The Layer dimension defines the vertical conceptual model for all application systems in an enterprise information technology system. It specifies the choice of technologies used and the way in which they are used. The Domain Dimension defines the horizontal conceptual model of an enterprise information technology system. It shows a business execution roadmap, which crosses multiple application systems. The architectural model includes:
The system infrastructure, which includes internet infrastructure, intranet infrastructure, extranet infrastructure and management infrastructure. These infrastructures are interconnected by the intranet infrastructure.
The system applications, which are categorized as internet applications, intranet applications, extranet applications and management application. These applications are consolidated onto related infrastructure. The internet applications are consolidated onto internet infrastructure, intranet applications are consolidated onto intranet infrastructure, and extranet applications are consolidated onto extranet infrastructure.
The interconnections and interoperations between any two different applications, which are supported by the infrastructures on which these two applications run.

Hardware components in the Infrastructure Layer of different domains are interconnected. Software components in the Infrastructure Layer provide location transparency and any-to-any real-time communication for components in upper layers. Software components in the Interface Layer support loose-coupled real-time interoperations among different application systems. Software components in the Application Layer implement specific business logic. All hardware and software components in an enterprise information technology system are configured, monitored, and managed by software components in the Management Domain.

### 4.1.3 View Dimension

Today's enterprise information technology systems are measured not only by their performance, but also by their time-to-market, and more significantly, by their ability to provide flexible solutions well-suited to their customer's needs. Business dynamism requires these systems to be agile and flexible enough to adopt new business strategies and produce new services. Traditional analysis and design approaches focus on either business architectures or technical solutions. The isolation between business analysis and IT solution design causes vertical silos inherent to system engineering methodology. The hierarchical nature of silos hinders the flexibility of an enterprise information technology system that allows it to adapt to business changes. An enterprise-wide unified approach is required for combining the knowledge of both business groups and IT groups to create an adaptive-to-change enterprise information technology system.

The integrated business enables organizations sell multiple existing products and services as a bundle package to their customers. It is a business strategy to quickly expand market opportunities, serve customers better, and increase revenue. Today's enterprise information technology systems try to replace stovepipe applications—one application system supports one business—with service-oriented framework-based applications to support enterprise-wide cross-business processes. However, the correlated nature of integrated businesses create tight coupling among different businesses. It conflicts with the principle of “loose coupling”, which is a golden rule of developing information systems. Most traditional A&D (analysis and design) approaches are technical-oriented approaches, which address a specific set of requirements. These approaches do not answer the question of how to use loosely-coupled information systems to computerize tightly-correlated businesses. Consequently, a business-oriented approach is required to drive the analysis and design of the enterprise information technology system in a coherent fashion.

In an iterative and incremental lifecycle, the system development is executed as a series of iterations. The iteration lifecycle is usually planned by weeks. In contrast, the development lifecycle of an enterprise information technology system may span several years. The conflicts between the short-period iteration lifecycles and the long-term system lifecycle require an end-to-end consistent framework to ensure that the implementation of an iteration follows up the ultimate goals of an enterprise information technology system.

For all these reasons, MDAF offers the View Dimension, which is a market-centric business-driven framework to model, analyze and design the solution to implement the functional requirements for application systems of an enterprise information technology system via a number of conceptual views. Each view is made up of the following two fundamental aspects:
The static structure aspect of a view exposes what elements are included and how they are organized.
The dynamic collaboration aspect of a view shows how elements interact with each other to achieve a specific goal.

By capturing functions and processes via a set of conceptual views, the tasks of business modeling and system development are seamlessly integrated together. All teams in an organization can understand, define and communicate the organization's business and the organization's enterprise information technology system in a modular fashion. Consequently any new businesses and the changes of existing businesses can be easily modeled. It also supports the rapid creation of solutions by extending existing service components.

MDAF View Dimension solves common pitfalls that occur in many traditional view-based methodologies via consistent aspects. When using a traditional approach to architect a system, the system architecture is represented using many independent models in different views. In this situation, the consistency between models cannot be guarantee, and no association is made between models. In contrast, the static structure and the dynamic collaboration aspects in MDAF View Dimension define the linkages among models in adjoined views. They create an automatic process for achieving cross-view consistency between neighboring views. As a result the implementation of each iteration will conform to an organization's business goals. They are the ultimate goals of the enterprise information technology system.

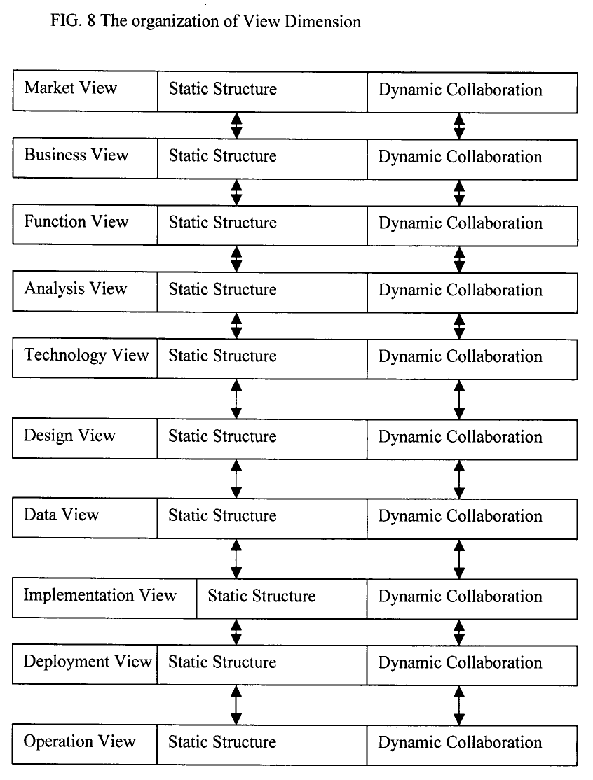

The views are not modeled in a waterfall process; instead they are modeled iteratively and incrementally. The information about an organization's businesses and application systems is documented in UML (unified modeling language) specified artifacts and text documents. FIG. 8 shows the organization of the View Dimension.

### 4.1.3.1 Market View

The purpose of the market view is to show a comprehensive picture of an organization's business environment.
Structure Aspect: shows the business goals of an organization, all businesses provided by the organization, products, services, customers, business partners, and also industry policies. The structure aspect is represented by a UML use case model.
Collaboration Aspect: shows how the identified business entities in the Structure Aspect interact with each other to achieve business goals through a series of business processes. The Collaboration Aspect is modeled by a UML activity model.

### 4.1.3.2 Business View

The business view addresses business modeling, which is the approach used to answer the question of how a business is operated.
Structure Aspect: exposes the explicit goal of a business, the business use cases included in the business, the products and services created by the business, the enterprise resources involved in the business. The resources include employees, computer systems, devices, and offices. The Structure Aspect of Business View is described by a UML use case model.
Collaboration Aspect: shows the possible operational processes for the business use cases in a business, the activities that must be undertaken to complete the processes and the relationships with the resources participating in the processes. These resources can be consumed, refined, created or used in the processes. Each process has a purpose, and all the processes collectively attempt to achieve a specific business goal. The Collaboration Aspect of Business View is represented by a UML collaboration model. It is used to understand a business, to expose threats or opportunities in the business, and to improve the business.

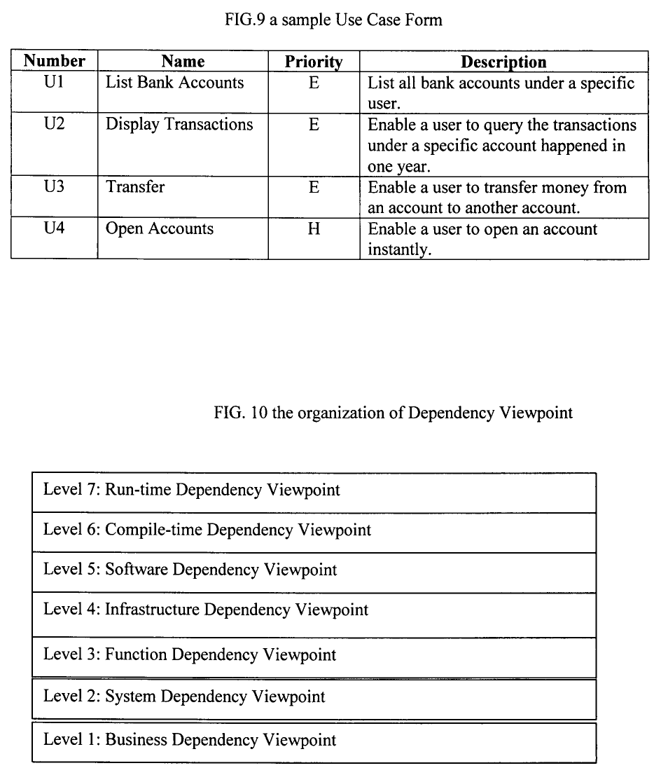

A use case form is used to record all business use cases captured in the business view. FIG. 9 shows a sample use case form for an online banking business. It includes the following columns:
Number Column: The use case number is the unique identifier for a business use case.
Name Column: The use case name represents the purpose of a business use cases.
Priority Column: The use case priority is rated based on the impact a business use case has on a business. It includes four levels:
   Essential
   High-Value
   Medium-Value
   Low-Value
Description Column: A use case description is a single sentence that describes the main function of a business use case and the participants.

### 4.1.3.3 Technology View

The Technology view seeks to create an optimistic technical set that will benefit all application systems in an enterprise information technology system. The technical set defines a suite of hardware and software, such as operation systems, application servers and messaging systems etc.
Structure Aspect: specifies the technical set of an enterprise information technology system, which includes hardware, software, frameworks, architectures, deployment configurations, networks and a shared infrastructure. It specifies the interfaces between different software, and the interfaces between software and hardware. It shows the cost of purchasing, operating and maintaining the technical set. The software technical set is represented by a UML component model, and the hardware technical set is represented by a UML deployment model.
Collaboration Aspect: shows how the activities of each business process will be implemented by software technologies and hardware technologies, and how these technologies collaborate to implement the business processes. The collaboration aspect is described by a UML collaboration model.

### 4.1.3.4 Function View:

The function view details requirement modeling. It captures what an application system is required to do, and what the system is not required to do.
Structure Aspect: exposes the businesses supported by an application system, the functions provided by the application system, and its actors. The Structure Aspect is represented by a UML use case model.
Collaboration Aspect: shows what business processes will be implemented by the application system, how the activities in the processes are implemented by the functions, and how the functions interact to achieve specific goals. The Collaboration Aspect also shows the flow of control as well as the flow of data between the different scenarios in a function. It is described by a UML activity model.

### 4.1.3.5 Analysis View:

The analysis view details problem modeling. It elaborates the conceptual domain objects and the business logic implemented by an application system.
Structure Aspect: exposes the domain objects involved in the functions of an application system. The structure aspect is represented by a UML object model.
Collaboration Aspect: shows the detailed workflow of business logic and the responsibility of domain objects in each workflow. It highlights the parallelism, communication, synchronization, and sequential interaction between domain objects. The collaboration aspect is modeled by a UML collaboration model.

### 4.1.3.6 Design View

The design view details solution modeling, in which an application system is represented by a logical model. It is the realization of the analysis view, and serves as an abstract representation of the implementation view.
Structure Aspect: defines the logical software and hardware components that implement domain objects and business logic. It also defines the architecture in terms of layers, subsystems, sub-network, packages, frameworks, classes and interfaces. The structure aspect is represented by a UML object model.
Collaboration Aspect: describes how logical software and hardware components collaborate to support the business processes. The collaboration aspect is modeled by a UML collaboration model.

### 4.1.3.7 Data View

The data view details data modeling, which accomplish the data persistence in database and the data exchange among heterogeneous applications.
Structure Aspect: specifies what data need to be persisted in databases, and what data need to be exchanged among application systems. It defines the logical and physical schema of data. The structure aspect is represented by an entity-relation (ER) model, a UML object model and a XML data model.
Collaboration Aspect: shows the manner in which data flows associated with business processes are manipulated by software and hardware components. The collaboration aspect is described by a UML collaboration model.

### 4.1.3.8 Implementation View:

The implementation view focuses on the implementation of an application system. It addresses problems that occur when code is edited, compiled, or tested.
Structure Aspect: specifies the mapping from logical software components to actual source code files, the mapping from logical hardware components to actual computers or devices. It defines coding standards, hardware configurations and team development environment. The structure aspect is represented by a series of text documents.
Collaboration Aspect: describes how actual software and hardware components collaborate to support the business processes. The structure aspect is represented by a UML collaboration model.

### 4.1.3.9 Deployment View:

The deployment view deals with aggregating and consolidating multiple applications onto a production environment.
Structure Aspect: defines the network topology of a production environment, and the component deployment architecture that specifies how software packages are deployed onto different nodes in the network. It shows how software and hardware components physically construct a production environment. It also shows how multiple software applications are consolidated onto a shared system infrastructure. The structure aspect is represented by a UML component model and a UML deployment model.
Collaboration Aspect: describes what businesses are supported in the production environment. It shows how computers, devices and software packages collaborate to execute automated business processes. The collaboration aspect is represented by a UML collaboration model.

### 4.1.3.10 Operation View:

The operation view focuses on production support, which ensures zero-downtime availability of an enterprise information technology system required by the new generation e-business.
Structure Aspect: specifies the factors that may affect the system runtime environment, and how to control these factors. The factors include installation, configuration, administration, performance monitoring, change management, incident management, and disaster recovery etc. The structure aspect is described by a series of text documents.
Collaboration Aspect: elaborates how the factors listed in the Structure Aspect collaborate with each other to solve problems that may occur during production runtime. The collaboration aspect is represented by a UML collaboration model.

### 4.1.4 Dependency Dimension

Dependency is a state where an element uses a functionality of anther element. It represents the collaborations between two elements. An element can be a business, a human being, an organization, an artifact, a software component, or a hardware component.

New generation e-business integrates businesses, clients, employees, business partners, and computer systems into an end-to-end business process. The nature of integrated business determines the correlations among businesses. The dependencies among businesses increase occurrences whereby a change in one business may cascade changes through related businesses in an organization. Consequently, the requirements for related application systems supporting these businesses have to be redefined as well.

End-to-end automated business processes provided by new generation e-business require high-performance zero-down-time computing infrastructure. The construction and maintenance of such infrastructure are cost-heavy. New generation enterprise information technology system enables an organization to aggregate and consolidate multiple applications onto a shared infrastructure. Fully utilizing the shared infrastructure not only decreases the total cost of owing an enterprise information technology system, but also simplifies the implementation of any-to-any interconnections and real-time interoperations among application systems. However, the shared and interconnected approach leads to a situation in which applications are working with a wide array of dependencies. An application's use of the infrastructure may interfere with another application's use. This creates a maintenance problem that while the infrastructure is shared by more applications, a larger number of failure points are generated. An effective framework is needed to minimize inter-application interference, and track ongoing changes in dependencies.

In object-oriented programming, component dependency occurs in many development workflows. For example, in design workflow, the dependencies are represented as the associations among classes. Software package dependency is also a common situation in object-oriented system development. To make a software package fully functional, other software packages on which it depends must be deployed with it together. The versions of the software packages must be traced to avoid backward compatibility breakage. Moreover, building a system is also dependency driven in the sense that a program can only be linked together once all its dependencies, i.e. the objects it is comprised of, have been compiled. Therefore a framework is required to minimize coupling and manage upcoming changes in order to avert or anticipate potential incompatibilities.

To solve those problems, the Dependency Dimension of MDAF defines a set of viewpoints to guide the activities of capturing dependencies, and a set of formula to visualize, optimize and manage these dependencies.

### 4.1.4.1 Dependency Viewpoint

The viewpoint strategy reveals the dependencies among businesses and an enterprise information technology system in an iterative and incremental paradigm. It exposes the dependency changes from the business to its IT implementation, and provides a consistent automated process to transfer business dependency to system component dependency. It helps the business teams assess the degree of overlaps and integration among different business. At the same time, it also helps IT teams evaluate the degree of decoupling of the enterprise information technology system supporting these businesses. FIG. 10 depicts the organization of Dependency Viewpoint.

Business Dependency Viewpoint: Artifacts in business dependency viewpoint create a comprehensive picture of dependencies among an organization's businesses, products, services, customers, partners, and industry policies.

System Dependency Viewpoint: Artifacts in system dependency viewpoint create a comprehensive picture of the dependencies among an organization's application systems that supporting its businesses.

Function Dependency Viewpoint: Artifacts in function dependency viewpoint represent the functional modules that have been implemented in the enterprise information technology system, and the dependencies among these modules. This view provides an approach to capture how a change on one functional module will affect other related modules.

Infrastructure Dependency Viewpoint: Artifacts in infrastructure dependency viewpoint expose dependencies among hardware, operating systems, data storage, middleware systems, and software products used in the application systems supporting a specific business.

Software Dependency Viewpoint: Artifacts in software dependency viewpoint capture the dependencies among software components encompassed in multiple systems involved in a specific business. This viewpoint and the Infrastructure Dependency Viewpoint show how the changes to a business will affect related application systems.

Compile-time Dependency Viewpoint: Artifacts in compile-time dependency viewpoints show the software packages used to build the source code of a specific application system, and the dependencies among these packages. This viewpoint helps developers identify whether there are dependency cycles among these packages.

Run-time Dependency Viewpoint: Artifacts in run-time dependency viewpoint describe software and hardware dependencies in multiple application systems, which are aggregated and consolidated onto a shared infrastructure. This viewpoint assists developers determine whether the failure of a system will affect the execution of other systems, and whether restarting a system will stop other systems.

### 4.1.4.2 Dependency Formula

MDAF's dependency formula includes the dependency syntax, the dependency degree, the dependency map, the dependency matrix, the methods of dependency capture, and the dependency analysis process.

### 4.1.4.2.1 Dependency Semantics

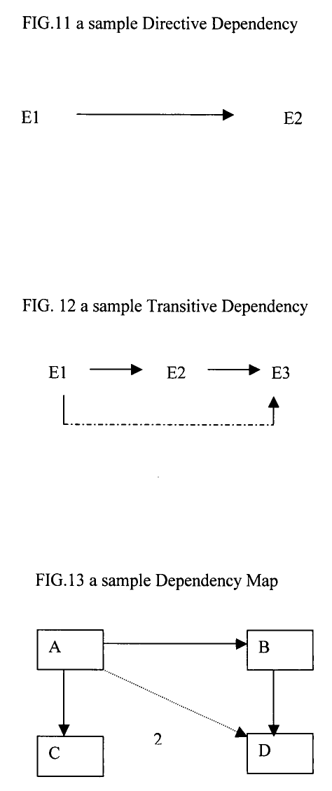

In MDAF, all element dependencies can be categorized into the following two groups:
Directive Dependency, which exists between two elements E1 and E2 if E1 can only function based on E2. FIG. 11 shows a sample directive dependency.
Transitive Dependency, which exists between two elements E1 and E3 if E3 can only function based on E2 that, in turn, can only function based on E1. FIG. 12 shows a sample transitive dependency.

### 4.1.4.2.2 Dependency Degree

The dependency degree between two elements i (source) and j (target) is defined as:

D(i,j)=0 if there is no dependency between elements i and j.

D(i,j)=1 if there is directive dependency between elements i and j.

D(i,j)=n+1 if element i transitively depends on element j through n intermediate elements.

### 4.1.4.2.3 Dependency Map

The dependency map represented by an object model provides a comprehensive picture of element dependencies at different workflows in the system development lifecycle. FIG. 13 shows a sample dependency map.
Object: represents an element, such as object A, B, C or D in FIG. 13.
Navigated line: represents a directive dependency, such as the line between objects A and B in FIG. 13.
Navigated dashed line: represents a transitive dependency, such as the line between objects A and D in FIG. 13.
Symbol: represents a dependency degree of a transitive dependency, such as the symbol labeling the line between objects A and D in FIG. 13.

### 4.1.4.2.4 Dependency Matrix

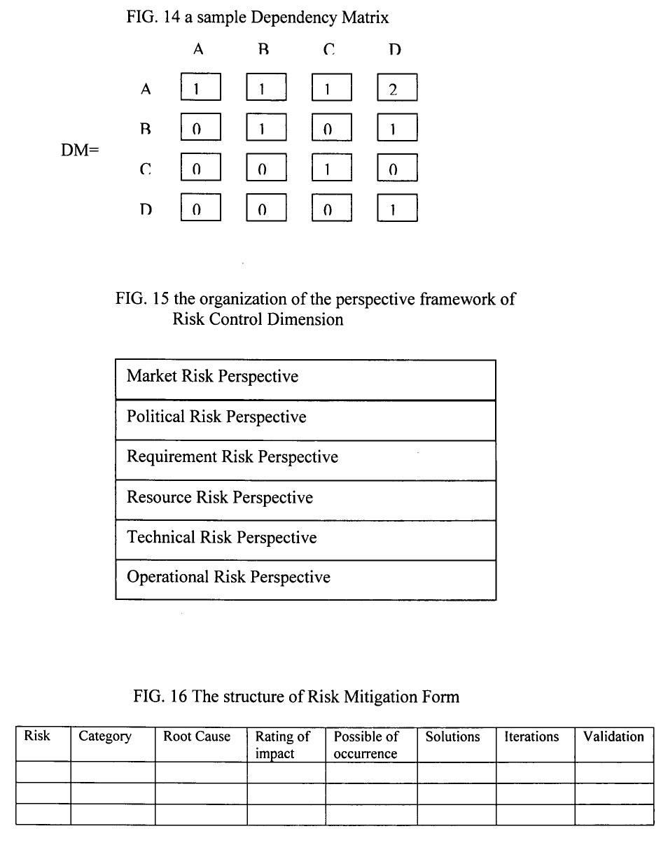

A dependency matrix (DM) containing all dependency degrees is created based on a dependency map. The rows of DM represent source elements, and the columns of DM represent target elements. In this matrix, a cell with a non-zero value denotes that a source element depends on a target element. The diagonal elements in the matrix are set to be 1 since an element is always totally dependent on itself. FIG. 14 is a sample dependency matrix derived from the dependency map presented in FIG. 13.

### 4.1.4.2.5 Dependency Capture

MDAF defines the following methods to capture the dependency between two elements:
Data Dependency, which is produced by data sharing between different elements. The data dependency represents the scenario where data are created in an element, but used by another element.
Explicit Control Dependency, which is produced when an element controls another element's operation by passing the control information into it.
Implicit Control Dependency, which is produced when an element controls the operation of another element via one of the following paradigms:
   Event-based Paradigm: When an element requires a service from another element, it triggers a specific event in an event system. The other element has been registered to listen to the event. When the specific event is generated, it activates the listening element to respond to the request. An event is a software component that indicates something has happened.
   Message-based paradigm: When an element requires a service from another element, it creates a request message and sends it to a messaging system. The other element receives the request message from the messaging system, and then sends the result back with a response message. A message is a software component that represents information which is sent from a sender to a receiver via a messaging system.
Inheritance Dependency, which represents a dependency between a base element and its derived elements. If a new element inherits attributes and functionalities of a pre-existing element, the new class is known as derived element, and the pre-existing element is referred to as parent element.
Resource Constraint Dependency, which is produced when multiple elements concurrently share a limited resource.
Sequential Dependency, which represents the scenario where an element can only be processed after the completion of processing another element.
Join Dependency, which represents the scenario where an element is not dependent on another element, but the final result depends on both elements.

### 4.1.4.2.6 Dependency Analysis Process

MDAF defines an iterative and incremental dependency analysis process. The following steps are included in the process:
Transformation, which transfers views in View Dimension into the dependency map. The methods defined in section 3.1.4.2.5 are used to capture the dependencies among hardware and software components. The approach defined in section 3.1.4.2.3 is used to create the dependency map.
Calculation, which captures the directive dependencies and transitive dependencies among elements. The formulas defined in section 3.1.4.2.2 are used to calculate the dependency degrees among hardware and software components.
Normalization, which constructs the dependency matrix. The approach defined in section 3.1.4.2.4 is used to build the dependency matrix.
Optimization. From business perspective, it is the activity that decreases the business elements involved in an organization's businesses by increasing sharing and correlations among business elements. From technical perspective, it is the activity that decreases the element dependencies of an enterprise information technology system by increasing the decoupling.
Refinement, which transfers the optimized solution back to the views in the View Dimension, schedules the identified elements into a set of agile iterations and defines the project scope.

### 4.1.5 System Quality Dimension

System quality represents how well an enterprise information technology system is implemented. It is usually documented in non-functional requirements. Traditional software development methodologies, such as object-oriented software development methodology, cannot address all system quality requirements for a new generation enterprise information technology system. Assurances must be made with respect to new critical system qualities to support new generation e-business, for example, system aggregation, real-time interoperation, system flexibility in the form of adaptive-to-change systems, and system robustness in the form of zero-down-time systems etc.

End-to-end automated business processes and integrated business services provided by new generation e-business have fundamentally changed missions of system quality. IT organizations have to ensure not only the traditional system quality of an application system but also the new enterprise-wide cross-systems quality. A new systematic approach is required to guide the development of non-functional requirements. This approach not only addresses the traditional system quality, but also provides a framework to implement the enterprise-wide cross-systems quality in iterative processes.

Achieving the goal of high system quality is a cross-systems aspect in the system development lifecycle of an enterprise information technology system. Traditional object-oriented development methodologies only define the requirements of system quality, such as performance, scalability, and so on. However, these methodologies do not specify approaches to ensure whether the implementation of an application system meets an acceptable enterprise-wide quality.

To solve all these problems, MDAF defines the System Quality Dimension intertwined with other dimensions to guide the development of non-functional requirements for enterprise information technology systems. It includes the perspective framework and the aspect framework. Each perspective encompassed within the perspective framework addresses a specific qualitative character of a system. The aspects nested in each perspective construct an aspect framework that ensures that the quality of an application system conforms to the enterprise-wide cross-system quality. The System Quality Dimension enables IT teams to create the predictive cross-systems qualities, and implement them in a set of agile iterations.

### 4.1.5.1 Perspective Framework

The system quality requirements for an enterprise information technology system can be categorized according to the following six role-based perspectives included in the perspective framework:

1) Run-time Perspective:
Performance: The performance quality is the ability to process a single-user operation within an acceptable time range.
Zero-down-time: The zero-down-time quality is the ability of having multiple application systems to collaborate with each other to complete an end-to-end business process under any condition. The integrated business service supported by the business process should be available in 24 hours a day and 7 days a week.
Availability: The availability quality shows essentially the percentage of time that an application system is available for use.
Real-time: The real-time quality is the ability for the components in an application system or the components from multiple applications to interoperate with each other in an acceptable latency bound.
Scalability: The scalability quality refers to the capacity of a system to increase total throughput under an increased load when resources are added.

2) Project Manager Perspective:
Feasibility: The feasibility quality refers to how easy an application system can be designed, built, deployed, and operated under constraints on resource, budget, and time.
Predictability: The predictability quality refers to the accuracy of the qualitative or quantitative prediction on a system's development.
Parallelism: The parallelism quality refers to the degree at which an application system can be developed in a parallel fashion.

3) Architect Projective:
Adaptability-to-Change: The Adaptability-to-Change quality refers to the ability of an enterprise information technology system to quickly adapt to fit the market changes or new requirements. This ability includes the speed with which existing functionalities can be integrated to support new business services, the speed with which the existing system can be extended to meet new requirements, the ease with which the development plan can be modified to fit the changes of the production release time, and the ease with which an existing design, architecture, and implementation can be changed to provide new functionalities etc.
Reusability: The reusability refers to the ability to reuse exiting components to build new applications for new business services.

4) Developer Perspective:
Interoperability: The interoperability quality refers to the capability of components of collaborating with each other and the ability to add new components in the collaborations.
Portability: The portability quality is the ability to move components from one operating platform to another platform.
Testability: The testability quality refers to how easy an application system can be fully tested. It includes the ease of determining test criteria on an application system, and the ease of performing test to verify whether the criteria have been met.

5) Administrator Perspective
Aggregation: The aggregation quality refers to the degree at which multiple applications can be consolidated onto a shared infrastructure. Two applications can be deployed onto a shared infrastructure only when there is no any runtime dependency between them.
Maintainability: The maintainability quality refers to how easy an application system can be monitored, configured and managed. It also refers to how quick and easy the technical supporters can be notified when performance degradation, failures or threshold violations are detected.
Serviceability: The serviceability quality indicates the ease with which an application system is fixed, or the hardware or software components of an application system are replaced. It also indicates how long business services are interrupted because of the system maintenance.

6) End-user perspective:
Automation: The automation quality refers to the degree at which the manual activities are involved in an end-to-end business process.
Usability: The usability quality refers to how easy an application system is used by end-users via a range of client devices, such as web browser or wireless devices.
Internationalization and Localization: The quality of Internationalization and localization is the ability to adapt an application system for non-native and non-cultural environment. Internationalization quality is the adaptability of an application system for potential use everywhere in the world. Localization quality is the adaptability of an application system for displaying and processing specific information based on countries, regions, cultures or languages.
Regulation: The regulation quality is the ability of an application system to conform to local and international laws, industry regulations, company policies, and other conventions.
Security: The security quality is the ability of an application system to reliably control, monitor, and audit access and actions to specific resources. It also refers to how easy an application system can be recovered from security failure.

### 4.1.5.2 Aspect Framework

Each quality perspective includes six nested aspects: problem, root cause, rating of impact, strategy, implementation and validation. These aspects construct the aspect framework to ensure the quality of an application system to meet enterprise-wide cross-systems quality.
Problem Aspect: The Problem Aspect documents the potential factors that affect a specific system quality.
Root Cause: The Root Cause Aspect exposes the source of a specific problem.
Rating of Impact: This aspect represents the importance of a specific problem. It includes four levels:
   Essential
   High-Value
   Medium-Value
   Low-Value
Strategy: The Strategy Aspect records an enterprise-level solution template that can solve a specific problem. If there is no appropriate template in the enterprise solution set, a new solution template will be created and added to the enterprise solution set.
Implementation: The Implementation Aspect records a customized solution in a particular project to solve a specific problem. This project-level solution is based on an enterprise-level solution template.
Validation: The Validation Aspect records how well a specific problem is solved, and whether the result is acceptable.

### 4.1.6 Risk Control Dimension

A risk is defined as a presently unknown or uncertain factor that may cause project failure in a system lifecycle. Predictive risk management is a critical subject that spans the entire system lifecycle. It is not solved in traditional object-oriented development methodologies. Predictive risk management enables IT organizations to identify risks early, create solutions early, and eliminate risks early.

It is especially important to develop new generation enterprise information technology systems. New generation enterprise information systems must support end-to-end automated business processes, and must respond to market changes quickly. Consequently, market risks will not only affect the businesses, but also impact the enterprise information technology system. Although market risks are significant risks affecting the system development lifecycle, traditional methodologies ignore them.

The development lifecycle of a complex enterprise information technology system usually spans a long-time period. During the development period, various types of risks may occur. Moreover, in certain situations, some identified risks may be solved as a lined result of the clear-up of other identified risks. Therefore, IT organizations require a consistent framework to manage risks across all projects for developing the enterprise information technology system.

Risk mitigation is a lifecycle-wide process in a system development lifecycle. It usually includes a set of iterations. Risks are identified and prioritized at the beginning of the development lifecycle, and then revised during the development of an iteration as some risks have been solved in previous iterations, and some new risks are exposed. Traditional methodologies do not provide approaches to integrate the risk management with iterative processes. To achieve predictable risk management, IT organizations need an approach to schedule risk identification, prioritization and mitigation into multiple agile iterations.

For all these reasons, MDAF defines the Risk Control Dimension to capture and manage potential risks in developing an enterprise information technology system. It includes the perspective framework, the aspect framework and the risk mitigation process. Each perspective represents a specific category of risks. These perspectives provide a consistent framework to identify and analyze risks. The aspects nested in each perspective provide a framework to record, trace and reuse the risk mitigation strategies. The risk mitigating process offers a systematic approach to identify, trace, analyze, prevent and eliminate risks.

### 4.1.6.1 Perspective Framework

The perspective framework consists of six category-based perspectives: Market Risk, Political Risk, Requirement Risk, Resource Risk, Technical Risk, and Operational Risk. FIG. 15 shows the organization of the perspective framework.

### 4.1.6.1.1 Market risk perspective

A market risk refers to the situations under which market changes may cause business loss or business requirement changes. Consequently, the computer systems in development supporting such businesses are required to be changed as well.

### 4.1.6.1.2 Political risk perspective

A political risk refers to the situations under which a project is competing with other internal or external projects, or the situations under which a project might conflict with a law, regulation or policy.

### 4.1.6.1.3 Requirement Risk Perspective

A requirement risk occurs when a use case or requirement is not understood.

### 4.1.6.1.4 Resource Risk Perspective

A resource risk occurs when a project does not have all required resources, such as the developers, devices or fund etc.

### 4.1.6.1.5 Technical Risk Perspective

A technical risk occurs when a project uses a technology that is unproven, cutting edge, or difficult to use.

### 4.1.6.1.6 Operational Risk Perspective

An operational risk occurs when an abnormal user behavior interrupts the services provided by an application system.

### 4.1.6.2 Aspect Framework

The aspect framework includes seven aspects: Problem, Root Cause, Rating of Impact, Possibility of Occurrence, Solution, Iteration and Validation.
Problem Aspect: The Problem Aspect documents the potential risks that may cause project failure in the system lifecycle.
Root Cause: The Root Cause Aspect exposes the source of a specific risk.
Rating of Impact: This aspect represents the degree with which a specific risk impacts a project. It includes four levels.
   Catastrophic
   High
   Moderate
   Minor

Possibility of Occurrence: This aspect identifies the likelihood that a specific risk will occur. It includes four levels:
Frequently
Likely
Occasionally
Seldom
Solution: The Solution Aspect records the approaches and implementations to solve a specific risk.
Iteration: The Iteration Aspect provides a way to allocate risks into development iterations based on their rating and possibility, and to trace the mitigation for a specific risk.
Validation: The Validation Aspect records how well a specific risk is solved, and whether the result is acceptable.

### 4.1.6.3 Risk Mitigation Process

The risk mitigation process is an iterative consistent framework to guide the risk mitigation activities, trace risk mitigation status and reuse the risk mitigation strategies. Two risk mitigation forms are used in the risk mitigation process. One is the Risk History List that records all identified risks and their solutions. The other is the Risk Exposure List that records all risks related to the application system in development. The structure of risk mitigation form, shown in FIG. 16, is based on the perspective framework in section 4.1.6.1 and the aspect framework in section 4.1.6.2.

The rows of Risk Mitigation Form list all identified risks. The columns of Risk Mitigation Form record the categories, the rating of impact, the possibility of occurrence, the solutions, the iteration schedules and the validation status for these identified risks.

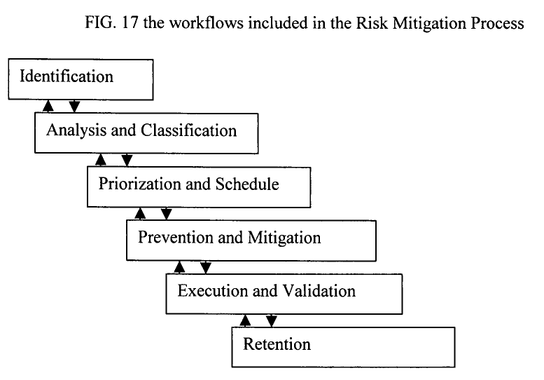

As shown in FIG.17, The risk mitigation process includes the following workflows:

### 4.1.6.3.1 Identification Workflow

The goal of Identification Workflow is to predict the risks that may be encountered when developing an application system. Three main outputs are created:
The establishment of a Risk Exposure List
The identification of risks using Risk History List and brainstorming exercise. If some risks recorded in the Risk History List are related to the application system in development, these risks and their solutions are imported into the Risk Exposure List. The new risks not included in the Risk History List are identified based on the perspective framework described in section 4.1.6.1.

### 4.1.6.3.2 Analysis and Classification (AC) Workflow

The goal of Analysis and Classification Workflow is to expose the characteristics of the identified risks. These characteristics are defined in the aspect framework described in section 4.1.6.2. The following outputs are generated:
The rating of impact for each risk
The possibility of occurrence for each risk
The root causes for each risk
The classification of risks. Once the root causes of a risk has been identified, this risk can be classified into evitable or inevitable risk.

### 4.1.6.3.3 Prioritization and Schedule (PS) Workflow

The goal of Prioritization and Schedule Workflow is to plan the high risks in earlier development iterations. The main deliverables include:
The risk priority based on the rating of impact and the possibility of occurrence defined in AC workflow.
The risk mitigation plan to schedule the high risks in early iterations.

### 4.1.6.3.4 Prevention and Mitigation (PM) Workflow

The goal of Prevention and Mitigation Workflow is to create a coherent strategy for mitigating the risks in a cost effective manner. The main outputs include:
The proactive measures to prevent the occurrences of the evitable risks.
The passive measures to mitigate the risk impact when the inevitable risks happen.

### 4.1.6.3.5 Execution and Validation (EV) Workflow

The goal of Execution and Validation Workflow is to remove the identified risks, and to verify that the evitable risks have been prevented by using proactive measures, and when the inevitable risks happen, impacts are limited in an acceptable range by using passive measures.

### 4.1.6.3.6 Retention Workflow

The goal of Retention Workflow is to record the processing status of the identified risks in the Risk Exposure List, and to record all identified risks and their solutions in the Risk History List. The main outputs are two risk mitigation forms: the Risk Exposure List and the Risk History List.

### 4.1.7 Iteration Dimension

New generation enterprise information technology systems give organizations many competitive advantages, such as integrated business services, one-stop real-time customer service, end-to-end automated business processes, and so on. However, migrating current enterprise information technology systems to new generation systems is a long-term and complex process. The entire system development lifecycle is usually separated into many projects, which are concurrently implemented by multiple teams. Each project has its own project development lifecycle, which is decomposed into multiple phases. Each phase usually consists of multiple small iterations. Each of these small short-term iterations is easy to manage and to complete successfully. The iterative methodology enables development teams to predict and control the development timeline, the resources, the budget and the deliverables. Although this methodology has many advantages, it is not sufficient to develop large enterprise information technology systems. Due to the lack of the framework to manage the end-to-end development process in this methodology, the entire development roadmap consisting of many projects further comprising many iterations cannot be predicted and optimized.

Traditional project management theories usually focus on the short-term project-level planning. However, they are not effective for the long-term system-level planning. The risks in building new generation enterprise information technology systems push IT organizations to find a new consistent framework that can seamlessly integrate project-level planning with system-level planning to generate project-level and system-level predictability.

There are conflicts between a parallel development environment, in which multiple teams are involved, and an iterative development methodology. Dependencies among the business processes that are implemented iteratively cause the developments to take place sequentially. Traditional estimating and planning theory does not provide effective solutions for these problems. Ignoring these problems will drastically impact the productivity of development teams, add extra complexity into system development lifecycle, and lead to unexpected delay and expense. IT organizations require an agile framework to address such problems in order to leverage the features of iterative development methodology, and the productivity of parallel development environment.

Most object-oriented software development methodologies are based on iterative and incremental processes. Agile iterations can be easily completed within predictive time and budget. However, too many short-term iterations will cause significant management and development overhead. Determining the best iteration size is an important task for a system development lifecycle. However, traditional software development methodologies cannot provide efficient ways to address this issue. Optimistic iterations are even more important to develop new generation enterprise information technology systems than to develop their ancestors because it can simplify the associations among iterations, promote concurrent development, and make project scope definition easier.

When developing a long-term enterprise information technology system, it is difficult for IT organizations to capture all uncertainties at the beginning. Moreover, during the development lifecycle, some certainties may become to uncertainties. All these factors may increase the probability of project failure. Traditional system development methodologies cannot address these issues. IT organizations require a well-defined, adaptive-to-change planning framework to adapt to the highly dynamic system development lifecycle.

For all these reasons, MDAF defines the Iteration Dimension to create optimistic agile iterations and promote the parallel development environment in which multiple development teams are involved. It includes the categories of iterations, the process to define optimistic iterations, and the process to manage dynamic iteration relationships and plan iterations in parallel development projects. The Iteration Dimension provides an adaptive-to-change planning framework to achieve the goal of predictable system-level plans and project-level plans. It ensures that the correct deliverables for an enterprise information technology system are implemented via an optimistic roadmap.

### 4.1.7.1 Iteration Category

An iteration is a development process in which scheduled requirements are implemented and a releasable system is built on production environment. The lifecycle of an iteration is usually measured in weeks. The Iteration Dimension uses a set of iterations as a consistent instrument to plan and trace the development lifecycle of an enterprise information technology system. These iterations can be categorized into two types:
System-level iteration: System-level iterations are used to create high-level predictable system development plans. The business use cases captured in View Dimension, specified in section 3.1.3, are scheduled into a set of system-level iterations. These iterations are then grouped into a set of projects. Based on their priorities and dependencies, the projects can be developed in parallel or sequentially. As a result, the targets of an enterprise information technology system determined in the View Dimension are iteratively planned into the project scopes via system-level iterations.
The scope of a specific project is the total scope of the iterations it includes. It represents the milestone a project should achieve.
Project-level iteration: Project-level iterations are used to create predictable project development plans. A project scope usually includes specific functional and non-functional requirements. These requirements are decomposed into a set of project-level iterations based on their priorities. A dedicated development team will implement these iterations in sequence.

The purpose of defining system-level iteration and project-level iteration is to iteratively obtain the predictive solution that answers the question of how an enterprise information technology system can be developed in parallel by multiple teams.

### 4.1.7.2 The Process to Define Optimistic Iterations

The iteration duration is mainly determined by time-frame and functionality. It means that for each iteration release, the scheduled requirements in an iteration must be implemented within a predefined period of time. These requirements usually refer to some use cases that an enterprise information technology system should support. The Iteration Dimension provides an agile process called CDESA, which stands for Creating discipline, Splitting discipline, Defining discipline, Estimating discipline and Adjusting discipline to determine the optimistic iteration duration.

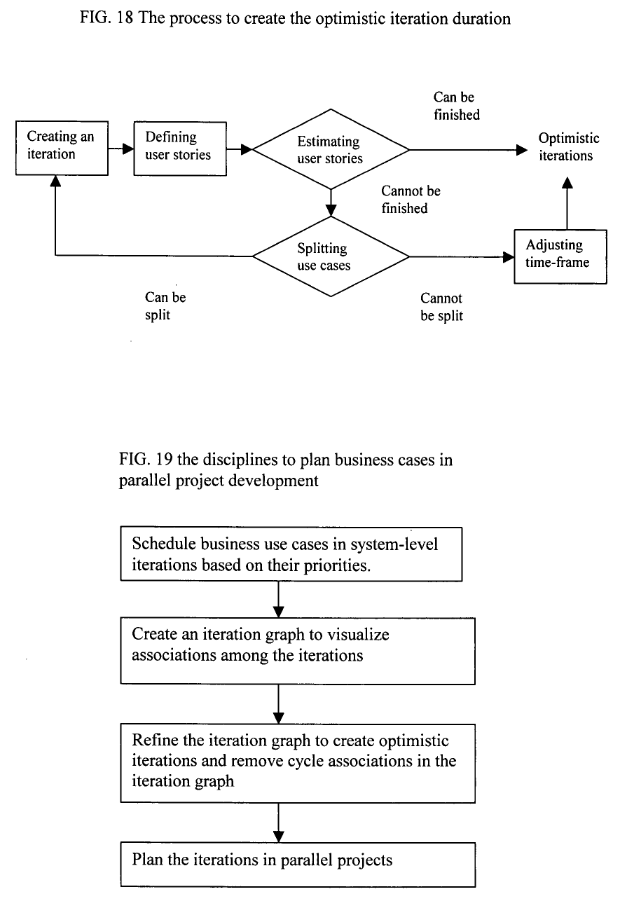

As shown in FIG. 18, the disciplines included in the CDESA process are defined as following:
The discipline of creating an iteration: In this discipline, the goal of an iteration is specified, the business use cases that should be implemented in this iteration are defined, and the required resources to complete this iteration are determined.
The discipline of defining user stories: The goal of an iteration is to deliver valuable features to users. Each use case can be expressed as a set of user stories. A user story is a description of the system's functionality from the user's perspective. It shows how a system executes user-desired business processes and returns valuable results to its users.
The discipline of estimating user stories: Each iteration can be assigned with a well-defined short lifecycle, such as 6 weeks. By evaluating the user stories of use cases associated with an iteration, a determination can be made whether the scheduled use cases can be completed at the end of an iteration duration.
The discipline of splitting business use cases: If a use case is too big or complex to fit within a single iteration, it should be split into several smaller use cases. These smaller use cases should be scheduled into multiple new iterations.
The discipline of adjusting pre-defined time-frame: However, due to the importance of a big use case and the difficulty of splitting the use case, it may not be possible to decompose it into multiple smaller use cases. The pre-defined time-frame should be adjusted long enough to accommodate the development duration for implementing this use case, such as 8 weeks.

### 4.1.7.3 The Process to Plan Optimistic Iterations in Projects

The Iteration Dimension defines an agile process to plan system-level iterations in projects. As shown in FIG. 19, this process includes Schedule Discipline, Visualization Discipline, Refinement Discipline and Planning Discipline.

### 4.1.7.3.1 Schedule Discipline

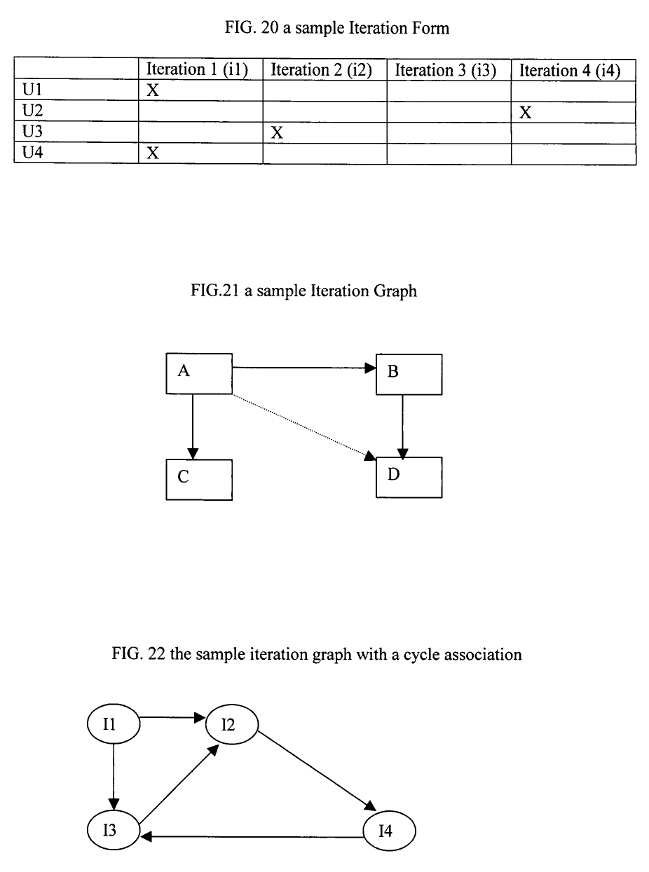

The milestone of the schedule discipline is to arrange all business use cases captured in the use case form, defined in 4.1.3.2, into system-level iterations. The arrangement is based on the priorities of use cases. Iteration Form, shown in FIG. 20, is used to record the arrangement.

The rows of Iteration Form list all business use cases captured in the use case form of the View Dimension. The columns of Iteration Form enumerate all scheduled iterations included in the system development lifecycle for an enterprise information technology system. The symbol X represents that a use case is assigned to a specific development iteration.

### 4.1.7.3.2 Visualization Discipline

The milestone of visualization discipline is to expose the associations among iterations by using Iteration Graph. The dependencies among business use cases assigned to different iterations determine the iteration associations. There are four types of associations with respect to iteration associations:
None: if the business use cases in iteration A do not depend on the business use cases in iteration B, there is no an association between these two iterations.
Finish to Start (FS): If the completion of implementing business use cases in iteration A is the precondition to start the development of business use cases in iteration B, the association between A and B is “Finish to Start”.
Injection: If the result achieved by implementing business use cases in iteration B is not the precondition to start the development of business use cases in iterationA, but is required to complete it, the association between A and B is defined as “Injection”.
Cycle: If iteration A has injection association with iteration B and vice versa, the association between A and B is “cycle”.

The iteration graph used in the visualization discipline provides a comprehensive picture of iteration associations. It is represented by an object model. FIG. 21 shows a sample iteration graph.
Object: represents an iteration, such as object A, B, C or D in FIG. 21.
Navigated line: represents an injection association between two iterations, such as the line between object A and B in FIG. 21. During the period of developing iteration A, the results from developing iteration B are required.
Navigated dashed line: represents a FS association, such as the line between objects A and D in FIG. 21. Starting the development of iteration A requires the results from developing iteration D.

### 4.1.7.3.3 Refinement Discipline

The milestone of the Refinement Discipline is to create optimistic iterations via the CDESA process defined in section 3.1.7.2, and to eliminate cycle associations from the Iteration Graph created in section 3.1.7.3.2.

The algorithm used in section 3.1.7.3.4 is to arrange iterations into parallel projects. It is based on the Topological Sorting Algorithm from Graph Theory. The generic Topological Sorting Algorithm cannot create an ordering if there is a cycle in a graph. FIG. 22 shows a sample iteration graph with a cycle association among iterations.

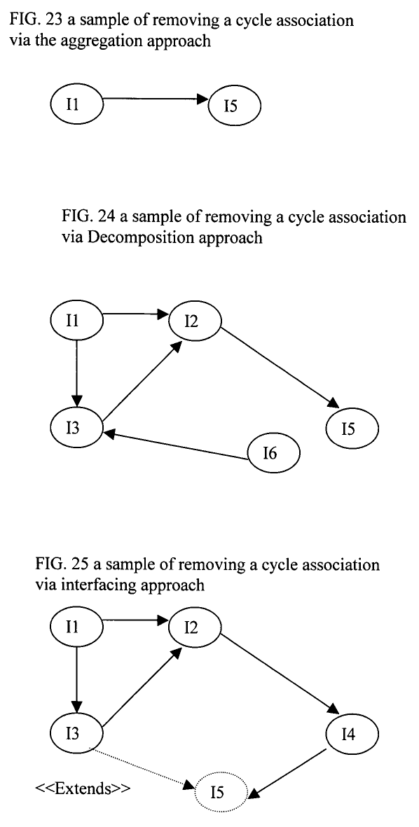

The Iteration Dimension defines the following three approaches to remove cycles from the iteration graph before using the graph to arrange iterations into parallel projects via the Topological Sort Algorithm.
Aggregation: Aggregate the iterations involved in a cycle into a consolidated iteration. Because the aggregation approach increases the business use cases in the single consolidated iteration, it is viable for the iterations with very short lifecycle. The CDESA process defined in section 3.1.7.2 is used to evaluate whether the development duration for the consolidated iteration is acceptable. FIG. 23 shows the cycle in FIG. 22 being eliminated by aggregating the involved iterations I2, I3 and I4 into a consolidated iteration I5.
Decomposition: Split one of the iterations involved in a cycle association into multiple smaller iterations to break the cycle. The business use cases included in the iteration are scheduled into the smaller iterations.
All iterations in the cycle are candidates for splitting. The principle to select an iteration from the candidates is to create minimum number of new iterations after splitting the select iteration. FIG. 24 shows the cycle in FIG. 22 being removed by decomposing an involved iteration I4 into two smaller iterations I5 and I6.
Interfacing: The root cause of a cycle association is that implementing the use cases in an iteration depends on the results from implementing the use cases in another iteration, and at the same time, to implement the latter iteration, the former one must be implemented. The interfacing approach breaks the cycle by adding an intermediate iteration into the cycle. The added iteration includes a mediate use case derived from the use cases in one of the iterations involved in the cycle.
The iterations involved in a cycle association can be categorized into Provider Iteration and Consumer Iteration. The Provider Iteration is the iteration that includes the use cases, from which a mediate use case is derived. The Consumer Iteration is the iteration whose use cases can only be implemented based on the results from implementing the use cases in the Provider Iteration.
The mediate use case only includes features from the use cases in the Provider Iteration that enable the implementation of the use cases in the Consumer Iteration. All other features of the use cases in the Provider Iteration will not be included in the mediate use case. These features will not be implemented until the Provider Iteration is developed.
FIG. 25 shows that a cycle association in the sample iteration graph in FIG. 22 is removed by adding an intermediate iteration, I5.

The CDESA process and the approaches to remove cycle associations are used together to refine the iteration graph defined in section 3.1.7.3.2 in order to obtain an optimistic non-cycle iteration graph. This graph will be used to plan iterations into parallel projects.

### 4.1.7.3.4 Planning Discipline

The development lifecycle of an enterprise information technology system may span several years. This long-term lifecycle is usually separated into many short-term project development lifecycles, which span several weeks or months. Planning projects is an iterative process. Only the early projects need to be planned up front. The goal of these projects is to implement the most important business use cases and eliminate the highest risks.

The Iteration Dimension defines an algorithm to arrange iterations into parallel projects. This algorithm is based on the Topological Sorting Algorithm. It categorizes all iterations in an optimistic non-cycle iteration group, obtained in section 3.1.7.3.3, into four groups:
Target iteration: Target iterations include the most important business use cases. These iterations must be completed in the project development lifecycle to meet business requirements.
Initial iteration: The initial iteration is an iteration with no precedent iterations. An initial iteration does not depend on results from any other iterations.
Aggregated iteration: When a project scope is determined, all iterations included in the project will be removed from the iteration graph and replaced by an aggregated iteration. The aggregated iteration does not have any precedent iteration.
Normal iteration: The normal iteration is an iteration with precedent iterations and successive iterations. They do not include the most important business use cases.

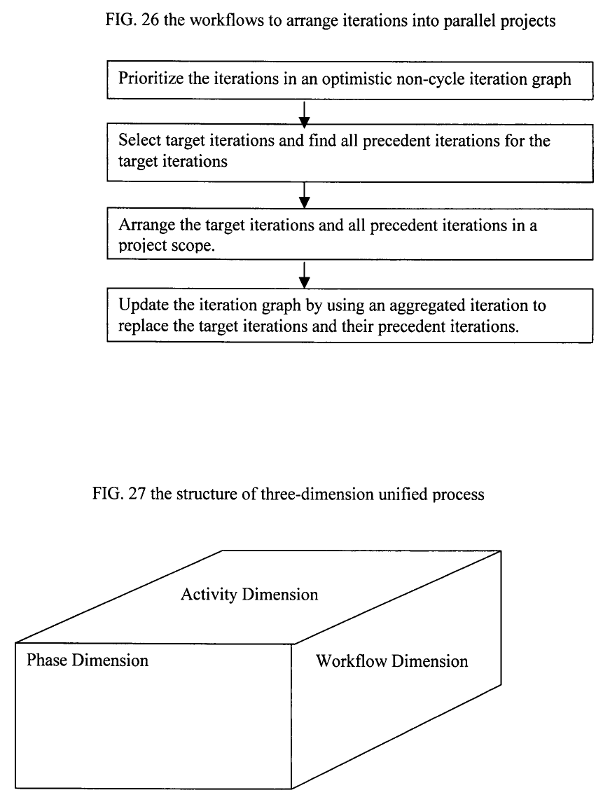

The execution workflows of this algorithm, shown in FIG. 26, are defined as following:
Prioritization Workflow: Each iteration is prioritized by the business use cases included in the iteration. The iteration's priority is the highest one among the priorities of business use cases. The priority of a business use case is specified in the use case form of the View Dimension, defined in section 4.1.3.2.
Sorting Workflow: Iterations with the highest priority are selected as the target iterations.
Arrangement Workflow: The target iterations and their preceding iterations are arranged in one project.
Aggregation Workflow: All target iterations and their preceding iterations are replaced by an aggregated iteration in the iteration graph.

When there is only one aggregated iteration in the iteration graph, it means that all system-level iterations have been planned into projects. It also means that all requirements for an enterprise information technology system have been solved. The development lifecycle of this system is over.

### 4.2 Three-Dimension Unified Process(3DUP)

Three-dimension unified process (3DUP) is a system development process to guide the design, implementation and management of enterprise information technology systems that support dynamic, real-time, automated, and integrated business environments. Traditional unified process (UP) is a software development process that is used to develop software with object-oriented technologies. 3DUP extends the traditional unified process. Its structure is illustrated by the “3DUP cube” shown in FIG. 27.

The 3DUP cube includes three intertwined dimensions. These dimensions are described below:
The Phase Dimension includes following six major lifecycle stages of 3DUP:
   1) Overview Phase—Determine the context, the optimistic agile iterations, and the project scope.
   2) Definition Phase—Define requirements and possible technical solutions.
   3) Modeling Phase—Design solutions that implement the required system functionalities.
   4) Construction Phase—Implement the solution designs.
   5) Release Phase—Verify the implementations for the solution designs and deploy software components onto a production environment.
   6) Production Phase—Provide system runtime support and change management.
The Workflow Dimension defines the sequence of steps that must take place in a phase. These steps are listed below:
   1) Vision—Determine business use cases, risks, iterations and the project scope.
   2) Requirement—Define functional and non-functional requirements
   3) Analysis—Produce an analysis model
   4) Design—Create a solution design
   5) Implementation—Implement software and hardware components based on the solution design
   6) Test—Verify whether the implementations meet the functional and non-functional requirements.
   7) Deployment—Build a production environment, and put the software components onto the production environment.
   8) Operation—Monitor the system's execution and solve runtime problems.
   9) Management—Generate well-defined iterative projects and manage system development lifecycle
The Activity Dimension defines the execution activities that should be performed to use a specific architecture framework in a workflow. It is the most important dimension in 3DUP since it enforces all actions that occur in a system development process to follow the models, methods, patterns, workflows and algorithms defined in the architecture framework. Any architecture framework can be injected into 3DUP. For a specific framework, a customized set of activities is required. When the MDAF is injected, the following execution activities are used:
   1) Projection—Decompose an enterprise information technology system into elements.
   2) Prioritization—Captures the critical requirements and high-priority risks.
   3) Schedule—Create optimized agile iterations.
   4) Assignment—Create parallel projects.
   5) Execution—Implement requirements and solve risks included in a project scope to achieve the project goal.

3DUP differs from traditional Unified Process (UP) or any other UP-based process in the following ways:
1) The traditional UP addresses only the software development lifecycle. 3DUP addresses the system lifecycle which includes both the software lifecycle and infrastructure lifecycle.
2) A traditional UP-based process can be represented using a two-dimensional table. 3DUP is represented in a cube structure, which differs from any other UP-based processes. The Activity Dimension in 3DUP provides a consistent framework for injecting an architecture framework into a development process. 3DUP breaks all actions that should be performed in a development workflow into a set of steps. These steps are forced to follow the execution activities defined in the Activity Dimension. These execution activities specify how to use the architecture framework in a development workflow.
3) 3DUP customizes the definitions, milestones and deliverables of phases and workflows to conform to specific activities for developing and managing an enterprise information technology system. The activities include creating optimized agile iterations and maintaining a zero-down-time production environment, etc. These specific activities cannot be found in any other UP-based processes.
4) 3DUP is a market-centric business-driven process. This means that the ultimate goal of an enterprise information technology system is to support long-term success of an organization. The factors that determine business and operation efficiency are captured in business models, and then implemented in the enterprise information technology system. These factors can be directly mapped to specific functional components included in the enterprise information technology system.
The market-centric business-driven process requires collaboration among the teams in an organization. For example, business teams determine the market and business strategies; development teams enable these business strategies in an enterprise information technology system; operation teams maintain the production environment of the enterprise information technology system. MDAF provides a unified framework that enforces all teams to use a consistent framework to transfer the factors that determine business and operation efficiency to an enterprise information technology system. The Activity Dimension of 3DUP specifies how to use MDAF in each workflow of 3DUP.
5) 3DUP is also a risk-mitigating process. The Activity Dimension of 3DUP provides an execution path that captures high-priority risks and schedules them in early iterations and early projects. It also provides a consistent framework to trace the priority changes of risks in a system development lifecycle.

### 4.2.1 Phase Dimension

The phase dimension represents the sequential aspect of 3DUP. It includes six lifecycle stages of 3DUP.

### 4.2.1.1 Overview Phase

The goal of Overview Phase is to determine the business context, the optimistic agile iterations and the project scope.

The essential activities of the Overview Phase include:
Exposing business cases and potential risks;
Identifying critical factors;
Scheduling the business cases and risks into system-level iterations;
Formulating project scope.

The milestone for the Overview Phase is the System Landscape. The following key deliverables are created in this phase:
Market Model
Business Model
Business Use Cases
Iteration Model
Project Vision
Project Development Plan

### 4.2.1.2 Definition Phase

The goal of Definition Phase is to capture functional and non-functional requirements, determine a complete technical solution and identify risks.

The essential activities of the Definition Phase include
Gathering functional requirements and nonfunctional requirements;
Creating overall technical infrastructures;
Capturing potential risks that may happen in the project;
Scheduling the requirements and risks into project-level iterations.

The milestone of the Definition Phase is the Project Objectives. The key deliverables include:
Use Case Model.
System Requirement Specification (SRS).
Quality Assurance Plan
Risk Management Plan
Project Status Assessment

### 4.2.1.3 Modeling Phase

The goal of Modeling Phase is to analyze the requirements, design proper solutions to meet the requirements, and eliminate identified risks.

The essential activities of the Modeling Phase include:
Elaborating the use cases to establish a solid understanding of business processes and domain objects;
Designing a software architecture and infrastructure architecture;
Performing application design, interface design and infrastructure design;
Creating the system test plan that verifies whether the application design, interface design and infrastructure design solve all problems and conform to system qualities.

The milestone of the Modeling Phase is the Solution Architecture. The key deliverables are:
Domain object
Analysis model
Design Model
Data Model
Infrastructure Architecture Document
Application Architecture Document
Test Plan Document
Project Development Plan
Quality Assurance Plan
Risk Management Plan
Project Status Assessment

### 4.2.1.4 Construction Phase

The goal of the Construction Phase is to implement the system solution, and make sure the solutions meet the requirements and have been properly implemented.

The essential activities of the Construction Phase include:
Iteratively implementing the infrastructure design by using related hardware and software, such as computers, devices, operating systems, data storage, ERP, middleware systems and interfaces etc.;
Iteratively implementing application by creating code, configuration files, data, message schemas, database scripts, and control scripts etc.;
Iteratively validating that the infrastructure implementation and application implementation solve all identified problems, eliminate all identified risks and conform to all defined system qualities via unit testing, integration testing, regression testing, stress testing and failover testing.

The milestone of the Construction Phase is the Initial Operational Capability, and the following key deliverables are generated:
Executable System.
Test Cases, Test Scripts, Test Results
Project Development Plan
Project Status Assessment

### 4.2.1.4 Release Phase

The Release Phase starts when beta testing is completed and ends when the system is deployed onto the production environment.

The essential activities of the Release Phase include:
Validating System Quality to ensure that the system implementation conforms to all functional and non-functional requirements, and the system can run and function when unexpected cases occur, such as server power-down etc, via user acceptance testing, regression testing, stress testing, and failover testing;
Fixing defects if unforeseen problems arise;
Tailoring the system to operate at the production environment;
Creating the user manuals and providing user consulting service;
Conducting product evaluation

In essence, this milestone is very simple—the product is released. The key deliverables of the Release Phase include:
The executable product
Test Cases, Test Scripts and Test Result
Disaster Recovery Plan Document
Production Run Book
Change Management Document
Release notes
Support materials, such as installation manual, user manual.
Project Development Plan
Project Status Assessment

### 4.2.1.5 Production Phase

The goal of Production Phase is to ensure that the system runs in stable manner in production environment, to manage the change, replacement or removal of system components, and to perform the disaster recovery.

The essential activities of the production phase include:
Monitoring the system to ensure that it runs and functions properly in 24*7*365;
Collecting, diagnosing and fixing runtime problems;
Managing the system changes, such as the addition of new software components, the removal of old software components, and the replacement of old hardware with new hardware;
Performing disaster recovery, such as a hardware power outages or a network error that disrupts processing.

The milestone for the Production Phase is Zero-down-time Production Environment. To achieve this milestone, the following key deliverables are required:
Incidence Management Document
Problem Management Document
Production Management Plan

### 4.2.2 Workflow Dimension

The workflow dimension represents the iterative and incremental aspect of 3DUP. It defines the execution path that should be taken through a development phase.

### 4.2.2.1 Vision Workflow

The goal of the Vision Workflow is to understand the business context, expose the potential risks, create optimized agile iterations and define the project scope. Most of the work in Vision Workflow occurs throughout the Overview Phase and Definition Phase during the initial stages of the system development lifecycle.

The key artifacts of the Vision Workflow are:
Market Model: The market model describes the overall business environment of an organization. It includes all businesses, business goals, products and services generated in the businesses, customers and partners of the businesses, as well as industry policies.
Business Model: The business model shows how a business is operated. It includes business use cases, products and services generated by a particular business, and enterprise resources involved in the business.
Business Use Cases: Business use cases can be thought of as contracts between business owners and IT organizations. They represent what and how business processes are implemented in a specific project.
Iteration Model: The iteration model includes system-level iterations that should be completed to build a system, and the relationships among these iterations. The main usage of the iteration model is to create optimized agile iterations and implement these iterations in parallel.
Project Vision: The project vision determines project scope, the costs and the work to be carried out. It also lists potential risks. It provides high-level requirements and design constraints for understanding a specific project.

### 4.2.2.2 Requirement Workflow

The goal of the Requirement Workflow is to gather functional requirements and non-functional requirements. The main work of the Requirement Workflow begins in the middle of the Overview Phase and occurs throughout the Overview Phase and the Definition Phase. It takes place in parallel with the Vision Workflow.

The key artifacts of the requirement workflow are:
Functional Use Case Model. The functional use case model consists of a set of functional use cases for a system or a portion of a system, together with a set of actors that interact with these functional use cases, thus describing the complete functionality of a system. It defines a model of the intended functions and environment of a system.
System Requirement Specification (SRS). The SRS document records the combined set of requirements, which include functional requirements and non-functional requirements. It is a contract between the client-side stakeholders and the development team.

### 4.2.2.3 Analysis Workflow

The goal of the Analysis Workflow is to produce an analysis model, which focuses on what the system needs to provide. The main work in Analysis Workflow begins toward the end of the Definition Phase and is the main focus of the Modeling Phase. It takes place in parallel with the Requirement Workflow.

The key artifacts of the Analysis Workflow are:
Domain objects: The domain objects are used to capture the responsibilities and collaborations in functional use cases. They represent the prototypical classes of a system, and serve as an abstraction that the system must implement.
Analysis model: The analysis model is an object model that describes how the functional use cases are executed to conform to the requirements of the business use cases. It includes all domain objects, relationships and collaborations involved in the functional use cases.

### 4.2.2.4 Design Workflow

The goal of the Design Workflow is to create the design model that can actually be implemented. The design model focuses on details of how a system implements the requirements. The Design Workflow is the primary modeling activity during the Modeling Phase and the early stages of the Construction Phase. The Analysis Workflow and the Design Workflow can occur in parallel.

The key artifacts of the Design Workflow are:
Design Model: The design model is an object model describing how functional use cases are implemented in a system. It is a comprehensive, composite artifact encompassing all classes, subsystems, packages, collaborations and the relationships among them.
Data Model: The data model specifies the logical data structure and physical structure for storing data in a database.
Infrastructure Architecture Document: The infrastructure architecture document specifies the infrastructure design to address how infrastructure-related requirements will be implemented. It includes the network architecture, interconnections, protocols and hardware components.
Software Architecture Document: The software architecture document specifies the software design to address how application-related requirements will be implemented. It includes the system architecture, interfaces, interoperations, class and database design.

### 4.2.2.5 Implementation workflow

The goal of the Implementation Workflow is to transform the design model into executable software component (code) and hardware component (computer or device). The Implementation Workflow begins in the Modeling phase and is the main focus of the Construction phase.

The key artifact of the Implementation Workflow is:
Executable System: The application design is implemented by software code, database tables and configuration files. The infrastructure design is implemented by software products, computers and devices. These hardware and software components are integrated together to construct an executable system, which meets all requirements determined in the Requirement Workflow.

### 4.2.2.6 Test Workflow

The goal of the Test Workflow focuses primarily on validating the system solution implementation, and evaluating the product quality. The work in the Test Workflow begins in the Definition Phase and is the main focus of the Construction Phase and Release Phase. The Implementation Workflow and the Test Workflow are executed in parallel.

The key artifacts in the Test Workflow are:
Test Plan. The test plan specifies the purpose and the goals for testing a project within a test. The test plan identifies the strategies to be used, and the resources necessary to execute the testing.
Test Case. The test case defines what function will be evaluated in a specific test, and what scenarios will be tested to verify this function.
Test Script. The test script specifies the manual or automated procedures used by testers to execute the tests.
Test Result. This document records results from the execution of test cases and Quality Assurance plans.

### 4.2.2.7 Deployment Workflow

The primary goal of the Deployment Workflow is to deploy the final product of the system solution onto a production environment, and to enable users to use it. The Deployment Workflow is the primary activity during the last part of the Construction phase, the Release phase, and the early stages of the Production phase.

The key artifacts of the Deployment Workflow are:
The executable product.
The release notes, describing the release for the end user.
Support material, such as installation manual, user manual, and so on.
Disaster Recovery Plan Document, which addresses the situation of when a disaster occurs, how to keep the system up and running seamlessly, and how to recover the system from the disaster.
Production Run Book, which records the system implementation and configuration in the production environment. It defines how to monitor, maintain and operate a system in its production environment.

### 4.2.2.8 Operation Workflow

The primary goal of the Operation Workflow is to operate and support a system in its production environment. The focus is to ensure that the system is running properly, the network is available, the appropriate data are backed up and restored as needed, and the runtime problems are captured and fixed. The Operation Workflow begins at the end of Release Phase and is the main focus of the Production Phase.

The key artifacts of the Operation Workflow are:
Change Management Document: The change management document defines why, when, who and how to implement a system change in the production environment of a system. It records all system changes for auditing and monitoring purpose.
Incidence Management Document: The incidence management document defines what instruments are used, and how to handle an incidence when it occurs.
Problem Management Document: The problem management document defines the tools and activities to diagnose the root cause of a problem in the production environment. It also defines the solution to fix it.

### 4.2.2.9 Management Workflow

The goal of Management Workflow is to provide an approach to generate predictable iterative projects, monitor the progress of projects, handle risks and manage system development lifecycle. The activities of Management Workflow occur throughout the entire system development lifecycle that includes the Overview Phase, the Definition Phase, the Modeling Phase, the Construction Phase, the Release Phase and the Production Phase.

The key artifacts of the Management Workflow are:
Project Development Plan: The project plan includes what need to be done in a project, by whom and when they need to be done, what resource this project requires, the assessments of the return on investment (ROI) provided by the project, and the estimated time and cost of this project.
Quality Assurance Plan: The QA plan is to serve as a guide to facilitate the establishment of QA activities within the phases and activities of the project development lifecycle. It defines the policy for QA activities, the organizational structure of the QA group, the responsibilities of the QA group and responsibilities of related groups.
Risk Management Plan: It provides a planned systematic framework to find potential risks, create the mitigation strategy, and trace the elimination of risks.
Project Status Assessment: The project status assessment records the project status and timeline. It is used to trace the activities, executors, and achievements throughout the project development lifecycle.
Production Management Plan: The production management plan defines the processes and instruments of planning, organizing, staffing, directing, budgeting, and controlling the production environment of a system.

### 4.2.3 Activity Dimension

The Activity Dimension represents the predictable aspect of 3DUP. Any architectural framework can be used as a predefined template to guide 3DUP workflow execution. For each specific architectural framework, a customized set of activities must be defined in Activity Dimension to specify how to inject the predefined template into 3DUP.

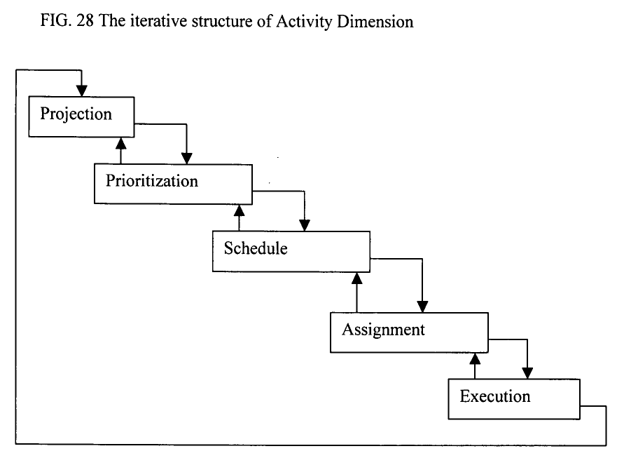

When MDAF is selected as the template, the following set of activities, shown in FIG. 28, is required. It includes projection activity, prioritization activity, schedule activity, assignment activity, and execution activity.

### 4.2.3.1 Projection Activity

EMDF addresses an enterprise information technology system as a single entity. By projecting this entity onto different predefined dimensions, we can capture the comprehensive concepts of this entity, decompose it into elements, and expose the collaborations among these elements. An element is an artifact that abstracts the essentials of a physical or logical resource involved in the system. It can be software, hardware, a human, an organization, a concept or policy, and so on.

### 4.2.3.2 Prioritization Activity

Each element has different value to an enterprise information technology system, and affects the enterprise information technology system in different ways. These elements are prioritized according to the rating of impact on business goal, project goal, functional requirements, system quality, and risk control to the enterprise information technology system.

### 4.2.3.3 Schedule Activity

The prioritized elements are scheduled in a set of agile iterations based on priority and dependency. These iterations can be system-level iterations or project-level iterations. The system-level iterations are used to decompose the development goal of an enterprise information technology system into multiple parallel projects. The main usage of project-level iterations is to decompose the development goal of a specific project into multiple tasks. A task is a smallest unit of work in 3DUP. It is performed to reach a specific status in a project development. The task concept exposes the dynamic aspect of a project development.

### 4.2.3.4 Assignment Activity

Agile iterations are planned into projects or tasks based on their priorities. These projects or tasks will be implemented in parallel. Consequently, the essential functional requirements, high-priority system quality requirements and high-priority risks will be implemented within earlier projects or tasks.

### 4.2.3.5 Execution Activity

The tasks are implemented and verified. The project goal is met with the result of implementing the tasks included in a project. Finally, the ultimate development goal of an enterprise information technology system is achieved based on the accumulation of milestones in multiple project developments.

### 4.3 Conclusion

In summary, the present invention provides a system-engineering framework which is extensible and multi-dimensional. This framework is leveraged to develop and manage complex enterprise information technology systems. It consists of two conceptual frameworks:
Multi-Dimensional Architecture Framework: an architecture framework that defines comprehensive concepts for modeling complex enterprise information technology systems via intertwined dimensions.
Three-Dimension Unified Process: a system development process that includes a set of phases, workflows and activities required to develop an enterprise information technology system.

The deliverables obtained by using extensible multi-dimensional framework to manage the system development lifecycle will be:
An adaptive-to-change quality-focused system architecture
Optimistic agile iterations
A market-centric business-driven risk-mitigating process.

Accordingly, it is to be understood that the embodiments of the invention herein described are merely illustrative of the application of the principles of the invention. Reference herein to details of the illustrated embodiments is not intended to limit the scope of the claims, which themselves recite those features regard as essential to the invention. It is also to be understood that after reading the foregoing specification, one of ordinary skill will be able to affect various changes, substitutions of equivalents and various other aspects of the invention without departing from the scope or spirit of the invention.

What is claimed is:

1. A system engineering framework for designing, developing and managing complex enterprise information technology systems. This framework is composed of:
a) A multi-dimensional architecture framework that provides a roadmap to guide the analysis and design of a comprehensive solution for developing an enterprise information technology system.
b) A three-dimension system lifecycle process that encompasses the activities required to develop an enterprise information technology system, to manage the projects for developing this system, to deploy the implementation of this system onto a production environment and to support the system after it is in the production environment.

2. The multi-dimensional architecture framework included in claim 1 further comprising a framework for developing complex enterprise information technology systems by organizing the analysis, design and implementation along an intertwined multi-dimensional structure, which includes:
a) Layer dimension, which consists of the layers and relationships, which define the vertical conceptual model of an enterprise information technology system.
b) Domain dimension, which consists of the domains and relationships, which define the horizontal conceptual model of an enterprise information technology system.
c) View dimension, which consists of a set of views (capturing the functions and processes) and a set of aspects (ensuring consistency and associations between models created in adjacent views).
d) Dependency dimension, which consists of a set of viewpoints, formulizations, graphs, processes and methods to capture, visualize, optimize and manage dependencies among the elements included in an enterprise information technology system.
e) System Quality dimension, which consists of the perspectives, categories and aspects to capture the non-functional requirements of an enterprise information technology system.
f) Risk Control dimension, which consists of the perspectives and aspects to capture potential risks in the lifecycle of an enterprise information technology system.
g) Iteration dimension, which consists of methods, graphs, formulas and processes to create optimistic agile iterations and promote parallel multi-team development environment.

3. The layer dimension presented in claim 2 further comprising
a) Application Layer, which implements business logic and interacts with users.
b) Interface Layer, which supports interoperability among software components running in different applications.
c) Infrastructure Layer, which provides a hardware and software platform for running a system, and supports any-to-any interconnections among different systems.

4. The application layer presented in claim 3 further comprising
a) Application implementation sub-layer, which includes software components that implement business logic, manage transactions, store data and interact with users.
b) Application management sub-layer, which provides tools to configure applications, to monitor application performance, to trace application activities, and to report application usage statistics.
c) Application architecture framework sub-layer, which specifies the concrete software architecture for an enterprise information technology system or an application system.
d) Application Technology sub-layer, which specifies the software stacks that are used in the applications of an enterprise information technology system, and also includes a software architectural template and best practices of using the select software.

5. The interface layer presented in claim 3 further comprising
a) Service contract sub-layer, which includes software components that offer a loose coupling mechanism to expose the functions provided by different applications, and to enable them to collaborate with each other.
b) Common Interface sub-layer, which includes software components that provide a set of software libraries or classes, which enable application components to invoke the underlying infrastructure via a standard way.
c) Interface management sub-layer, which provides tools to configure service contracts, to monitor interoperation performance among application components, to trace interoperation activities among application components, and to report interoperation status statistics.
d) Interface architecture sub-layer, which specifies the concrete architecture for developing interface components.

6. The infrastructure layer presented in claim 3 further comprising
a) Infrastructure Software Implementation sub-layer, which specifies the software products that are used in an enterprise information technology system, and their installation, configuration and interoperation.
b) Infrastructure Hardware Implementation sub-layer, which specifies the hardware products that are used in an enterprise information technology system, and their installation, configuration and interoperation.
c) Infrastructure Management sub-layer, which provides tools to configure infrastructure, to monitor infrastructure performance, to trace infrastructure activities, and to report infrastructure status statistics.
d) Infrastructure Architecture sub-layer, which specifies the networking topology and system deployment architecture to optimize the structure and system quality for the infrastructure of an enterprise information technology system.
e) Infrastructure Technology sub-layer, which specifies the hardware and software stacks that are used in the infrastructure of an enterprise information technology system, and also includes an infrastructure architectural template and the best practices of using the select hardware and software.

7. The domain dimension presented in claim 2 further comprising
a) Internet Domain, in which the hardware and software allow clients to interact with an enterprise information technology system via public networking, such as Internet or wireless network.
b) Intranet Domain, in which the hardware and software provide core business services, enable employees to access the application systems via Intranet, and implement real-time automated integrations among the internal application systems of an organization.
c) Extranet Domain, in which the hardware and software provide the interconnection and real-time interoperability between the enterprise information technology system and partner computer systems.
d) Management Domain, which includes all software components in the management sub-layer of application layer, interface layer and infrastructure layer to provide a consolidated platform to configure, monitor and manage all application systems of an enterprise information technology system.

8. The combination of the domain dimension of claim 3 with the layer dimension of claim 7 further comprising an architectural model for enterprise information technology systems, which includes:
a) The system infrastructure, which includes internet infrastructure, intranet infrastructure, extranet infrastructure and management infrastructure, which are all interconnected by the intranet infrastructure.
b) The system applications, which are categorized as internet applications, intranet applications, extranet applications and management application consolidated on its related infrastructures.
c) The interconnections and interoperations between any two different applications, which are provided by the infrastructures on which these two applications run.

9. The view dimension of claim 2 further comprising
a) View framework, which analyzes the functional requirements, and designs the solution via a number of different conceptual views.
b) Aspect framework, which ensures the consistency of deliverables created in different views.

10. The view framework presented in claim 11 further comprising
a) Market view, which shows a comprehensive picture of the business environment of an organization.
b) Business view, which addresses business modeling.
c) Technology view, which provides the optimized technical set used in all applications of an enterprise information technology system.
d) Function view, which solves the issues of requirement modeling.
e) Analysis view, which addresses the problem modeling.
f) Design view, which addresses the solution modeling.
g) Data view, which addresses the data modeling.
h) Implementation view, which solves the problems that happen in code-time, compile-time and test-time.
i) Deployment view, which deals with the issues of aggregating and consolidating multiple applications on a production environment.
j) Operation view, which focuses on the production support providing zero-down-time enterprise information technology systems required by new generation e-businesses.

11. The aspect framework presented in claim 9 further composing
a) Static Structure aspect, which exposes the elements included in a view and the relationships among these elements.
b) Dynamic Collaboration aspect, which shows how the elements interact with each other to achieve specific goals.

12. The dependency dimension presented in claim 2 further comprising
a) Dependency viewpoint framework, which exposes the dependencies among the businesses in an organization and the dependencies among the elements consisting of an enterprise information technology system that supports these businesses in a consistent paradigm, visualizes the dependencies changes from businesses to its computerized implementation, and provides an automated process to transfer business dependency to system component dependency.
b) The dependency semantics, which define the different types of collaborations between two elements.
c) The formula for calculating dependency degree between two elements.
d) The methods for capturing the dependencies between two elements.
e) A dependency map, which presents a comprehensive picture of the element dependencies at different workflows of a system development lifecycle.
f) A dependency matrix, which contains all dependency degrees created in a dependency map.
g) A dependency analysis process, which is an iterative and incremental process for analyzing the dependencies among elements.

13. The dependency viewpoint framework of claim 12 further comprising
a) Business Dependency Viewpoint, which creates a comprehensive picture of the dependencies among the businesses of an organization, the products and services created in the businesses, the customers, the partners and the industry policies.
b) System Dependency Viewpoint, which creates a comprehensive picture of the dependencies among the application systems of an organization that support its businesses.
c) Function Dependency View, which describes the dependencies among the functional modules of an enterprise information technology system.
d) Infrastructure Dependency View, which exposes the dependencies among the hardware, operating systems, data storages, middleware systems and software products, which are used in multiple application systems to support a particular business.
1e) Software Dependency View, which exposes the dependencies among the software components encompassed in multiple application systems involved in a business.
f) Compile-time Dependency View, which exposes the software packages used to implement and compile the source code of a particular application system, and the dependencies among these packages.
g) Run-time Dependency View, which exposes the software and hardware dependencies in multiple application systems aggregated and consolidated in a unified shared infrastructure.

14. The dependency semantics of claim 12 further comprising
a) Directive Dependency, which exists between two elements E1 and E2 if E1 can only function based on E2.
b) Transitive Dependency, which exists between two elements E1 and E3 if E3 can only function based on E2 that in turn can only function based on E1.

15. The formula for calculating dependency degree presented in claim 12 further comprising
a) The degree 0 when there is no dependency between two elements;
b) The degree 1 when there is directive dependency between two elements; and
c) The degree n+1 when an element transitively depends on another element through n intermediate elements.

16. The methods for capturing dependencies presented in claim 12 further comprising
a) Data Dependency, which is produced by data sharing between different elements.
b) Explicit Control Dependency, which is produced when an element controls another element's operation logic by passing control information into it.
c) Implicit Control Dependency, which is produced when one element controls the logic of another via event-based paradigm or message-based paradigm.
d) Inheritance Dependency, which represents a dependency between a base element and its derived elements.
e) Resource Constraint Dependency, which is produced when multiple elements concurrently share a limited resource.
f) Sequential Dependency, which represents the scenario where an element can only be processed after the completion of processing another element.
g) Join Dependency, which represents the scenario where an element is not dependent on another element, but the final result depends on both elements.

17. The dependency map of claim 12 further comprising
a) Object, which represents an element.
b) Navigated line, which represents the directive dependency.
c) Navigated dashed line, which represents the transitive dependency.
d) Symbol, which represents the dependency degree of a transitive dependency.

18. The dependency matrix of claim 12 further comprising
a) The rows including the source elements,
b) the columns including the target elements,
c) the intersection cells representing the dependency degrees from source elements to target elements.

19. The dependency analysis process presented in claim 12 further comprising
a) Transformation, which transfers views in View Dimension into the dependency map.
b) Calculation, which captures the directive dependencies and transitive dependencies among elements.
c) Normalization, which constructs the dependency matrix.
d) Optimization, which reduces business elements in an organization's businesses, or reduces element dependencies in an enterprise information technology system.
e) Refinement, which transfers the optimized solution back to views in the View Dimension, schedules the identified elements in a set of agile iterations and defines project scopes.

20. The System Quality dimension of claim 2 further comprising:
a) A role-based perspective framework, which groups the non-functional requirements into different categories.
b) An aspect framework, which ensures that the quality of one application system conforms to the enterprise-wide cross-system quality.

21. The role-based perspective framework of claim 20 further comprising
a) Run-time Perspective, which includes the qualities of performance, zero-down-time, availability, reliability, real-time and scalability.
b) Project Manager Perspective, which includes the qualities of feasibility, predictability and parallelism.
c) Architect Perspective, which includes the qualities of adaptability-to-change and reusability.
d) Developer Perspective, which includes the qualities of interoperability, portability and testability.
e) Administrator Perspective, which includes the qualities of aggregation, maintainability and serviceability.
f) End-user perspective, which includes the qualities of automation, usability, accessibility, regulation, security, localization and internationalization.

22. The aspect framework of claim 20 further comprising
a) Problem, which captures the potential factors that affect a particular quality of the system.
b) Root cause, which exposes the source causing a specific problem.
c) Rating of impact, which represents the importance of a specific problem.
d) Strategy, which records the selected enterprise solution framework that can solve a specific problem
e) Implementation, which records the customized solution in a particular project to solve a specific problem
f) Validation, which records whether a specific problem is solved.

23. The risk control dimension of claim 2 further comprising
a) A category-based perspective framework, which is a consistent framework to identify and manage risks.
b) An aspect framework, which is a framework to record, to trace and to reuse the risk mitigation strategies.
c) A risk mitigation process, which is an iterative consistent framework to guide the risk mitigation activities, to trace risk mitigation status, and to reuse the risk mitigation strategies.

24. The category-based perspective framework of claim 23 further comprising
a) Market risk perspective, which exposes the risks that represent the situations in which the market changes cause business loss or business requirement changes.
b) Political risk perspective, which exposes the risks that represent the situations in which the project is competing with other projects (internal or external) or in which the project might conflict with a law, regulation or policy.
c) Requirement risk perspective, which exposes the risks when use cases or requirements are not understood.
d) Resource risk perspective, which exposes the risks when the project does not have all of the resources (human, equipment, or money) required for successful completion.
e) Technical risk perspective, which exposes the risks when the project might use a technology that is unproven, cutting edge, or difficult to use.
f) Operational risk perspective, which exposes the risks when the abnormal behaviors of users cause the breakdown or slowdown of the services provided by an application system.

25. The aspect framework of claim 23 further comprising
a) Problem, which captures the potential risks that may cause a project failure in a system lifecycle.
b) Root Cause, which exposes the source causing a specific problem.
1c) Rating of Impact, which represents the impact that a specific risk will have on a project.
d) Possibility of Occurrence, which identifies the likelihood that a particular risk will occur.
e) Solution, which records the approach to solve a particular problem.
f) Iteration, which provides a way to allocate risks into development iterations based on their rating and possibility, and to trace the mitigation for a specific risk.
g) Validation, which records whether a specific risk is mitigated, and whether the result is located in the acceptable range.

26. The risk mitigation process of claim 23 further comprising
a) Identification Workflow, which is to capture the risks to develop an application system.
b) Analysis and Classification (AC) Workflow, which is to expose the characteristics of the identified risks.
c) Prioritization and Schedule (PS) Workflow, which is to plan the high risks in earlier development iterations.
d) Prevention and Mitigation (PM) Workflow, which is to create a coherent strategy for mitigating the risks in a cost effective manner.
e) Execution and Validation (EV) Workflow, which is to remove the identified risks, and to verify that the evitable risks have been prevented by using designed proactive measures, and when the inevitable risks happen, their impacts are mitigated in acceptable range by using the designed passive measures.
f) Retention Workflow, which is to record the processing status of the identified risks in the Risk Exposure List, and to record all identified risks and their solutions in the Risk History List.

27. The risk mitigation form used in the risk mitigation process of claim 26 further comprising a two-dimension structure in which the rows list all identified risks, and the columns record the categories, the rating of impact, the possibility of occurrences, the solutions, the iteration schedules and the validation status for these identified risks.

28. The iteration dimension of claim 2 further comprising
a) The iteration categories, which group the iterations for different usages.
b) The process to define optimistic iterations called CDESA Process.
c) The process to plan optimistic iterations in projects.

29. The iteration categories of claim 28 further comprising
a) System-level iteration, which is used to create high-level predictable system development plan.
b) Project-level iteration, which is used to create predictable project development plan.

30. The CDESA (Creating-Defining-Estimating-Splitting-Adjusting) process of claim 28 further comprising
a) Creating discipline, in which the goal of an iteration is specified, the business use cases that should be implemented in this iteration are defined, and the required resources to complete this iteration are determined.
b) Defining discipline, in which the business cases are defined as a set of user stories.
c) Estimating discipline, in which we can determine whether a specific business case can be completed in the time-frame
d) Splitting discipline, in which if a specific business case is too big to fit within a single iteration, it should be split into smaller cases.
e) Adjusting discipline, in which the pre-defined time-frame is extended to accommodate the development duration for implementing a big use case that cannot be split.

31. The process to plan optimistic iterations in projects of claim 28 further comprising
a) Schedule discipline, which is a discipline to arrange all business use cases captured in a form called Iterations Form in iterations.
b) Visualization Discipline, which is a discipline to expose the iteration associations among iterations by using Iteration Graph.
c) Refinement Discipline, which is a discipline to create optimistic iterations via the CDESA process and eliminate cycle associations from the Iteration Graph via the methods of removing the dependency cycle.
d) Planning Discipline, which is a discipline to arrange the iterations including important business use cases in early parallel projects via a topological-sorting-based method.

32. The Iteration Form of claim 31 further comprising the rows representing business cases, the columns representing iterations and the symbol X representing that a use case is assigned to a specific development iteration.

33. The iteration associations of claim 31 further comprising
a) FS association (Finish to Start), which represents an iteration association that starting to implement the business cases in iteration B is required to use the results achieved by implement the business cases in iteration A.
b) None association, which represents an iteration association that the business cases in iteration A do not depend on the business cases in iteration B.
c) Injection dependency, which represents an iteration association when the result achieved by implementing business use cases in iteration B is not the precondition to start the development of business use cases in iterationA, but is required to complete it.
d) Cycle dependency, which represents an iteration dependency that iterationA has injection dependency with iteration B and verse vice.

34. The iteration graph of claim 31 further comprising
a) Target iteration, which includes the most important business cases or highest risks.
b) Initial iteration, which is the iteration without any precedent iteration.
c) Aggregated iteration, which replace a group of iterations included in a particular project scope in an iteration graph.
d) Normal iteration, which represents the iteration with precedent iterations and successive iterations.

35. The methods of removing the dependency cycle of claim 31 further comprising
a) Aggregation, which is a method to aggregate the iterations involved in a cycle to one iteration.
b) Decomposition, which is a method to separate one of the iterations involved in a cycle into multiple smaller iterations to break the cycle.
1c) Interfacing, which is a method to add a new iteration providing the mediate services to one of the iterations involved in a cycle.

36. The decomposition methods of claim 35 further comprising a principle to select an iteration that will be split into multiple smaller iterations to remove an iteration dependency cycle.

37. The topological-sorting-based method of claim 31 further comprising
a) Prioritization workflow, which is a workflow in which each iteration is prioritized according to the business cases included in the iteration.
b) Sorting workflow, which is a workflow in which the highest iterations are selected as target iterations.
c) Arrangement workflow, which is a workflow in which the target iterations and their preceding iterations are arranged in one project.
d) Aggregation, which is a workflow in which all target iterations and their precedent iterations are replaced by an aggregated iteration to the iteration graph.

38. The system lifecycle process of claim 1 further comprising a three-dimension structure, which includes
a) Phase Dimension, which represents the major stages of a system lifecycle.
b) Workflow Dimension, which represents the sequence of steps that must take place in a development phase.
c) Activity Dimension, which defines the execution activities that should be performed to use a specific architecture framework in development workflows.

39. The phase dimension of claim 38 further comprising
a) Overview Phase, which is a stage to determine the context, optimized agile iteration and scope.
b) Definition Phase, which is a stage to define the requirements and overall technical solutions.
1c) Modeling Phase, which is a stage to capture the requirements and design the solutions.
d) Construction Phase, which is a stage to implement the solutions, and verify the implementation.
e) Release Phase, which is a stage to deploy the system product onto a production environment.
f) Production Phase, which is a stage to support the system execution and manage changes.

40. The workflow dimension of claim 38 further comprising
a) Vision workflow, which is a step to capture the business cases, risks, iterations and project scope.
b) Requirement workflow, which is a step to capture the functional and non-functional requirements.
c) Analysis workflow, which is a step to produce an analysis model.
d) Design workflow, which is a step to create the design model.
e) Implementation workflow, which is a step to transform the design model into code, computer or device.
f) Test workflow, which is a step to verify the system implementation and evaluate the product quality.
g) Deployment workflow, which is a step to put the system product to the production environment.
h) Operation workflow, which is a step to operate and support the system in a production environment.
i) Management workflow, which is a step to generate the predictive iterative projects and manage system lifecycle.

41. The activity dimension of claim 38 further comprising a framework to inject an architecture framework into each workflow of a system lifecycle process to make the independency between the architecture framework and the system lifecycle process, and at the same time, organize the activities of the system lifecycle along the predefined models of the architecture framework.

42. The framework presented in claim 41 further comprising
a) Project activity, which is an execution activity that addresses an enterprise information technology system as a single entity, captures the comprehensive concepts of this system by projecting this entity on different predefined dimensions, decompose it into elements, and expose the collaborations among these elements.
b) Prioritization activity, which is an execution activity that prioritizes the identified elements based on the rating of impact on the functional requirements, system quality and risk control.
c) Schedule activity, which is an execution activity that schedules the prioritized elements in a set of agile iterations based on priority and dependency.
d) Assignment activity, which is an execution activity that plans the agile iterations into projects or tasks based on their priorities.
e) Execution activity, which is an execution activity that the identified projects or tasks are implemented and verified.
